(19) United States
(12) Patent Application Publication
(10) Pub. No.: US 2024/0270546 A1
(43) Pub. Date: Aug. 15, 2024

(54) MACHINE CONNECTIVITY MODULE WITH INTEGRATED BEACON

(71) Applicant: Oshkosh Corporation, Oshkosh, WI (US)

(72) Inventors: Korry D. Kobel, Oshkosh, WI (US); Fredric L. Yutzy, Oshkosh, WI (US); Dan Adamson, Oshkosh, WI (US); Stefan Eshleman, Oshkosh, WI (US); Greg Pray, Oshkosh, WI (US)

(73) Assignee: Oshkosh Corporation, Oshkosh, WI (US)

(21) Appl. No.: 18/645,981

(22) Filed: Apr. 25, 2024

Related U.S. Application Data
(63) Continuation-in-part of application No. 17/576,798, filed on Jan. 14, 2022.
(60) Provisional application No. 63/462,133, filed on Apr. 26, 2023.
(60) Provisional application No. 63/138,015, filed on Jan. 15, 2021.
(60) Provisional application No. 63/137,893, filed on Jan. 15, 2021.
(60) Provisional application No. 63/137,950, filed on Jan. 15, 2021.
(60) Provisional application No. 63/138,016, filed on Jan. 15, 2021.
(60) Provisional application No. 63/137,955, filed on Jan. 15, 2021.
(60) Provisional application No. 63/137,867, filed on Jan. 15, 2021.
(60) Provisional application No. 63/138,024, filed on Jan. 15, 2021.
(60) Provisional application No. 63/138,003, filed on Jan. 15, 2021.
(60) Provisional application No. 63/137,996, filed on Jan. 15, 2021.
(60) Provisional application No. 63/137,978, filed on Jan. 15, 2021.

(51) Int. Cl. B66F 9/075; H04L 67/00; H04L 67/12

(52) U.S. Cl. CPC B66F 9/07581; B66F 9/0759; H04L 67/12; H04L 67/34

(57) ABSTRACT

A machine includes a chassis, a series of tractive elements coupled with the chassis, a prime mover configured to drive the plurality of tractive elements, and a connectivity module with a beacon communicably coupled with the machine. The connectivity module is configured to receive an input relating to a criteria of the machine, and communicate an output, the output including the criteria of the machine, to one or more components of the machine.

### CROSS-REFERENCE TO RELATED PATENT APPLICATIONS

This application (a) is a continuation-in-part of U.S. patent application Ser. No. 17/576,798, filed on Jan. 14, 2022, which claims the benefit of and priority to U.S. Provisional Application No. 63/137,950, filed on Jan. 15, 2021, U.S. Provisional Application No. 63/137,955, filed on Jan. 15, 2021, U.S. Provisional Application No. 63/137,996, filed on Jan. 15, 2021, U.S. Provisional Application No. 63/138,003, filed on Jan. 15, 2021, U.S. Provisional Application No. 63/138,015, filed on Jan. 15, 2021, U.S. Provisional Application No. 63/138,016, filed on Jan. 15, 2021, U.S. Provisional Application No. 63/138,024, filed on Jan. 15, 2021, U.S. Provisional Application No. 63/137,867, filed on Jan. 15, 2021, U.S. Provisional Application No. 63/137,893, filed on Jan. 15, 2021, and U.S. Provisional Application No. 63/137,978, filed on Jan. 15, 2021; and (b) claims the benefit of and priority to U.S. Provisional Application No. 63/462,133, filed on Apr. 26, 2023, all of which are hereby incorporated by reference herein.

### BACKGROUND

Work equipment such as lifts and telehandlers sometimes require tracking, tasking, monitoring, and servicing at a work site. Managers and operators of working machines typically rely on discrete systems, applications, and methods to perform these functions for each piece of equipment. Often, physical inspection of a machine is necessary to determine a state, status, or condition of the machine. Additionally, on work sites encompassing a large area or involving many pieces of equipment, it is often time consuming for equipment operators or service technicians to determine the statuses for a large number of machines prior to assigning a machine to a task.

### SUMMARY

One exemplary implementation of the present disclosure relates to a machine. The includes a chassis, a series of tractive elements coupled with the chassis, a prime mover configured to drive the plurality of tractive elements, and a connectivity module with a beacon communicably coupled with the machine. The connectivity module is configured to receive an input relating to a criteria of the machine, and communicate an output, the output including the criteria of the machine, to one or more components of the machine.

Another exemplary implementation of the present disclosure relates to a vehicle. The vehicle includes a chassis, a series of tractive elements coupled with the chassis, a prime mover configured to drive the tractive elements, and a connectivity module with a beacon communicably coupled with the vehicle. The connectivity module is configured to receive an input relating to a criteria of the vehicle and communicate an output, the output including the criteria of the vehicle, to one or more components of the vehicle.

Another exemplary implementation of the present disclosure relates to a fleet connectivity system. The fleet connectivity system includes a user device and a machine. The machine includes a chassis, a series of tractive elements coupled with the chassis, a prime mover configured to drive the tractive elements, and a connectivity module with a beacon communicably coupled with the machine. The connectivity module is configured to receive an input relating to a criteria of the machine and communicate an output, the output including the criteria of the machine, to one or more components of the machine. The user device is configured to receive the input from a user and communicate the input to the connectivity module.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

FIG. 1 is a schematic representation of a work machine including a machine control module, according to some embodiments.

FIG. 2 is a schematic representation of a local fleet connectivity system, according to some embodiments.

FIG. 3 is a schematic representation of a local fleet connectivity system with a connectivity module and an indicator, according to some embodiments.

FIG. 4 is a schematic representation of a work site and equipment staging area with a fleet connectivity system deployed, according to some embodiments.

FIG. 5 is an illustrative representation of a work site with a fleet connectivity system connecting two pieces of equipment, according to some embodiments.

FIG. 6 is an illustrative representation of a piece of equipment with a fleet connectivity system providing connectivity to a remote user, according to some embodiments.

FIG. 7 is a schematic representation of a work site with a fleet connectivity system deployed with connectivity to off-site systems, according to some embodiments.

FIG. 8 is an illustrative representation of an apparatus configured with a fleet connectivity system, according to some embodiments.

FIG. 9 is an illustrative example of a graphical user interface of a fleet connectivity system, according to some embodiments.

FIG. 10 is an illustrative representation of a work machine with machine specific output data connected to a fleet connectivity system, according to some embodiments.

FIG. 11 is an illustrative representation of work machines configured for use in a fleet connectivity system, according to some embodiments.

FIG. 12 is an illustrative representation of a work machine provisioned with an integrated connectivity module and beacon, according to some embodiments.

FIG. 13 is a flow diagram of a process for implementing components of a fleet connectivity system, according to some embodiments.

FIG. 14 is a perspective view of the work machine of FIG. 1 configured as a firefighting vehicle provisioned with an integrated connectivity module and beacon, according to an example embodiment.

FIG. 15 is a side view of the work machine of FIG. 1 configured as a mixer truck provisioned with an integrated connectivity module and beacon, according to an example embodiment.

FIG. 16 is a side view of the work machine of FIG. 1 configured as a refuse vehicle provisioned with an integrated connectivity module and beacon, according to an example embodiment.

FIG. 17 is rear perspective view of the work machine of FIG. 1 configured as a delivery vehicle provisioned with an integrated connectivity module and beacon, according to an example embodiment.

FIG. 18 is front perspective view of the work machine of FIG. 1 configured as a delivery vehicle provisioned with an integrated connectivity module and beacon, according to an example embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Referring to the figures generally, various exemplary embodiments disclosed herein relate to systems and methods for work machine connectivity modules with integrated beacons. For example, a connectivity module may be configured with various components (e.g. a telematics control unit, a multi-function light beacon, one or more multi-channel communication modems, etc.), and may be programmed to communicate an output to and/or control a component of the work machine (e.g. an LED beacon, a work machine light, an interface, a control system, a wheel, etc.) in accordance with a determined criteria in order to provide a coordinated and integrated result (e.g. identification of a particular machine by activation of a beacon, etc.). The connectivity module with integrated beacon may, for example, indicate a condition, state, and/or status of a work machine (e.g., state of charge, fuel level, etc.), use data from an IMU to determine a work machine is being towed, use connectivity module memory for over-the-air (OTA) software updates for the module and the machine as a whole, use memory to store onboard manuals, use memory to store advertising files, etc. In an exemplary embodiment, the connectivity module and beacon are integrated into a single device. In some embodiments, the connectivity module includes other working components (e.g., one or more antennas, one or more power sources, one or more positioning systems, one or more local fleet connectivity processors, and one or more interface blocks, one or more machine connectivity provisions, one or more memory devices, GPS sensor, GPS antenna, GPS/GNSS sensors and/or antennas, a wireless transmitter, Bluetooth transmitter, Bluetooth antenna, WiFi module, WiFi antenna, cellular data transmitter, cellular data antenna, pressure transducer, light sensor, accelerometer, inertial measurement unit, memory storage, processor, multiple/colored LEDs, etc.).

Further referring generally to the figures, various exemplary embodiments disclosed herein relate to systems and methods for interactivity and productivity that may enhance local fleet connectivity. For example, the connectivity module with integrated beacons may be integrated on one or more work machines, and may be communicably coupled to other components of a fleet connectivity system (e.g., another work machine, a product development hub, a network, etc.). According to an exemplary embodiment, Bluetooth Low Energy (BLE) Machine to Machine (M2M) communication protocols may be used to expand communication at a worksite/jobsite via local connectivity between work machines at the worksite/jobsite (e.g., via low energy wireless data network, a mesh network, a satellite communications network, a cellular network, or a wireless data network, etc.). In some embodiments, a local fleet connectivity system may include various work machines, interface modules, work site equipment, communications devices, communications networks, user interface devices, devices hosting self-forming network software, and user interfaces. Local fleet connectivity system users may include equipment user, equipment maintainers, equipment suppliers, worksite/jobsite supervisors, remote users, etc. In some embodiments, interconnectivity and productivity related data is exchanged via the work machine connectivity module with integrated beacon. The connectivity module may be communicably connected to a work machine controller, host one or more connectivity and productivity application, and/or communicate with other components of the fleet connectivity system. The information provided to the local fleet connectivity system may further be communicated to users via a user interface (e.g., via the connectivity module with integrated beacon). In some embodiments, the user interface may include a real time map, showing a current machine location, a machine status. In some embodiments, the user interface includes a color coded warning indicator, an audible alarm, or another indicator structured to communicate to the machine operator that the work machine is in a location or state that requires the attention of the operator.

In some embodiments, the local fleet connectivity system may support one or more machine identity and location services. In some implementations, the one or more machine identity and location service may generate a graphic display of a machine population. In some embodiments, the machine identity and location system graphic display may comprise a map of the machine population. In some embodiments, the graphic display of the machine population may be generated using one or more selectable dynamic filters. The one or more selectable dynamic filters may be applied to identify a particular machine population or sub-population at one or more work sites. The one or more selectable dynamic filter may perform filtering according to one or more selectable attributes. The one or more selectable attributes may comprise, for example, a machine type, a machine model number, a machine manufacturer, a machine location, a machine work site tag, a machine status, a fuel status, a use status, etc. In some embodiments, the machine identity system graphic display may be presented to a local user via a work site network. In some embodiments, the local fleet connectivity system graphic display may be presented to a remote user via one or more communications networks. In some instances, the remote user may remotely apply desired filters or configuration setting to the local fleet connectivity system graphic display presented to a local user on a local user interface device. In some embodiments, the local fleet connectivity system graphic display filters or configuration setting may generate a one or more displays of the status or condition of work machines within a population of work machines in a combined view or in separate views.

In some embodiments, the connectivity module with integrated beacon may indicate a status or condition of a work machine. The status or condition of a work machine may include, for example, a fuel level, an ignition on/off condition, a condition of movement, a state of charge status, a DTC status, and a repair status. In some embodiments, the beacon device may be selectively commanded to indicate a particular status or condition of work machines within a population of work machines for work machines that are within a selected range of a user device. In some embodiments, the status or condition of particular work machines at a work site indicated by connectivity module with integrated beacon may be selected independent of or in conjunction with one or more filter criteria that a user applies to a population of sub-population of work machines within the equipment identity system.

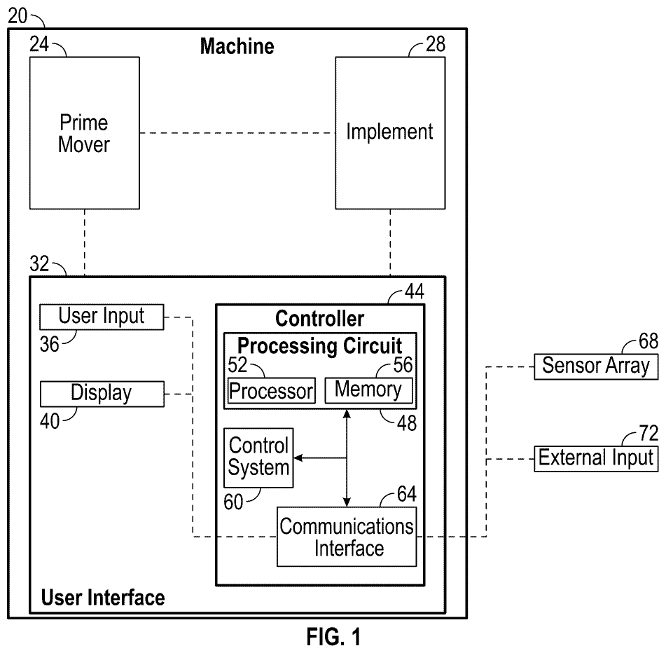

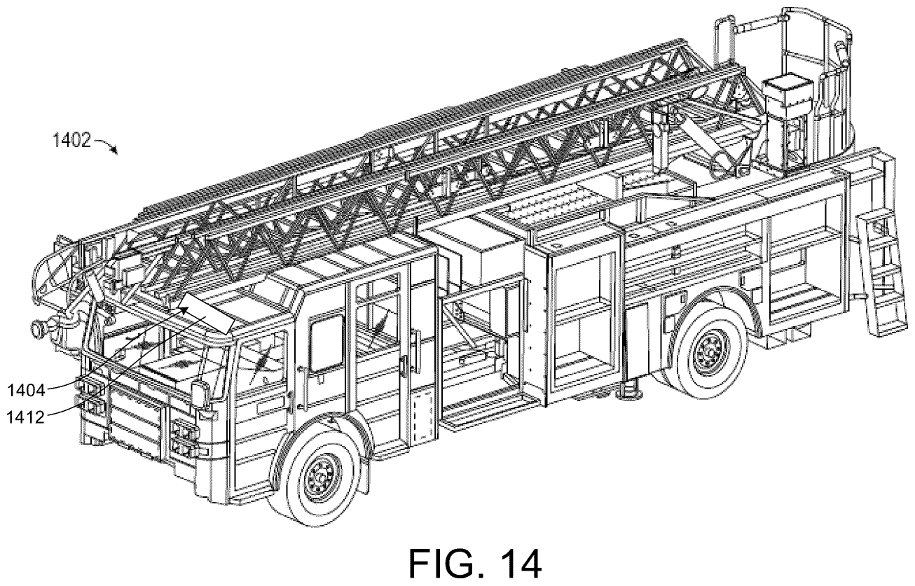

As shown in FIG. 1, a work machine 20 (e.g., a telehandler, a boom lift, a scissor lift, etc.) includes a prime mover 24 (e.g., a spark ignition engine, a compression ignition engine, an electric motor, a generator set, a hybrid system, etc.) structured to supply power to the work machine 20, and an implement 28 driven by prime mover 24. In some embodiments, the implement 28 is a lift boom, a scissor lift, a telehandler arm, etc. In other embodiments, the work machine 20 is configured as another machine or vehicle. For example, the work machine 20 may be configured as a refuse vehicle, a concrete mixer, a fire fighting vehicle, an airport fire fighting vehicle, a lift device (e.g., a boom lift, a scissor lift, a telehandler, a vertical lift, etc.), a crane, a tow truck, a military vehicle, a delivery vehicle, a mail vehicle, a boom truck, a plow truck, a farming machine or vehicle, a construction machine or vehicle, a coach bus, a school bus, a semi-truck, a passenger or work vehicle (e.g., a sedan, a SUV, a truck, a van, etc.), and/or still another vehicle. As will be discussed below, FIGS. 14-18 illustrate various examples of how the work machine 20 may be configured as another work machine or vehicle. Although only certain work machines and/or vehicles are show, it should be understood that the work machine 20 may be configured as another work machine and/or vehicle, or for use in another application that is not shown.

A user interface 32 is arranged in communication with the prime mover 24 and the implement 28 to control operations of the work machine 20 and includes a user input 36 that allows a machine operator to interact with the user interface 32, a display 40 for communicating to the machine operator (e.g., a display screen, a lamp or light, an audio device, a dial, or another display or output device), and a controller 44.

As the components of FIG. 1 are shown to be embodied in the work machine 20, the controller 44 may be structured as one or more electronic control units (ECU). The controller 44 may be separate from or included with at least one of an implement control unit, an exhaust after-treatment control unit, a powertrain control module, an engine control module, etc. In some embodiments, the controller 44 includes a processing circuit 48 having a processor 52 and a memory device 56, a control system 60, and a communications interface 64. Generally, the controller 44 is structured to receive inputs and generate outputs for or from a sensor array 68 and external inputs or outputs 72 (e.g. a load map, a machine-to-machine communication, a fleet management system, a user interface, a network, etc.) via the communications interface 64.

The control system 60 generates a range of inputs, outputs, and user interfaces. The inputs, outputs, and user interfaces may be related to a jobsite, a status of a piece of equipment, environmental conditions, equipment telematics, an equipment location, task instructions, sensor data, equipment consumables data (e.g. a fuel level, a condition of a battery), status, location, or sensor data from another connected piece of equipment, communications link availability and status, hazard information, positions of objects relative to a piece of equipment, device configuration data, part tracking data, text and graphic messages, weather alerts, equipment operation, maintenance, and service data, equipment beacon commands, tracking data, performance data, cost data, operating and idle time data, remote operation commands, reprogramming and reconfiguration data and commands, self-test commands and data, software as a service data and commands, advertising information, access control commands and data, onboard literature, machine software revision data, fleet management commands and data, logistics data, equipment inspection data including inspection of another piece of equipment using onboard sensors, prioritization of communication link use, predictive maintenance data, tagged consumable data, remote fault detection data, machine synchronization commands and data including cooperative operation of machines, equipment data bus information, operator notification data, work machine twinning displays, commands, and data, etc.

The sensor array 68 can include physical and virtual sensors for determining work machine states, work machine conditions, work machine locations, loads, and location devices. In some embodiments, the sensor array includes a GPS device, a LIDAR location device, inertial navigation, or other sensors structured to determine a position of the work machine 20 relative to locations, maps, other equipment, objects or other reference points.

In one configuration, the control system 60 is embodied as machine or computer-readable media that is executable by a processor, such as processor 52. As described herein and amongst other uses, the machine-readable media facilitates performance of certain operations to enable reception and transmission of data. For example, the machine-readable media may provide an instruction (e.g., command, etc.) to, e.g., acquire data. In this regard, the machine-readable media may include programmable logic that defines the frequency of acquisition of the data (or, transmission of the data). The computer readable media may include code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, etc.).

In another configuration, the control system 60 is embodied as hardware units, such as electronic control units. As such, the control system 60 may be embodied as one or more circuitry components including, but not limited to, processing circuitry, network interfaces, peripheral devices, input devices, output devices, sensors, etc. In some embodiments, the control system 60 may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the control system 60 may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on). The control system 60 may also include programmable hardware devices such as field programmable gate arrays, programmable array logic, programmable logic devices or the like. The control system 60 may include one or more memory devices for storing instructions that are executable by the processor(s) of the control system 60. The one or more memory devices and processor(s) may have the same definition as provided below with respect to the memory device 56 and processor 52. In some hardware unit configurations, the control system 60 may be geographically dispersed throughout separate locations in the machine. Alternatively, and as shown, the control system 60 may be embodied in or within a single unit/housing, which is shown as the controller 44.

In the example shown, the controller 44 includes the processing circuit 48 having the processor 52 and the memory device 56. The processing circuit 48 may be structured or configured to execute or implement the instructions, commands, and/or control processes described herein with respect to control system 60. The depicted configuration represents the control system 60 as machine or computer-readable media. However, as mentioned above, this illustration is not meant to be limiting as the present disclosure contemplates other embodiments where the control system 60, or at least one circuit of the control system 60, is configured as a hardware unit. All such combinations and variations are intended to fall within the scope of the present disclosure.

The hardware and data processing components used to implement the various processes, operations, illustrative logics, logical blocks, modules and circuits described in connection with the embodiments disclosed herein (e.g., the processor 52) may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, or state machine. A processor also may be implemented as a combination of computing devices, such as a combination of a DSP and a microprocessor, a plurality of microprocessors, one or more microprocessors in conjunction with a DSP core, or any other such configuration. In some embodiments, the one or more processors may be shared by multiple circuits (e.g., control system 60 may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The memory device 56 (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory device 56 may be communicably connected to the processor 52 to provide computer code or instructions to the processor 52 for executing at least some of the processes described herein. Moreover, the memory device 56 may be or include tangible, non-transient volatile memory or non-volatile memory. Accordingly, the memory device 56 may include database components, object code components, script components, or any other type of information structure for supporting the various activities and information structures described herein.

In an exemplary embodiment, the memory device 56 stores instructions for execution by the processor 52 for a process to automatically generate a work site equipment grouping. The process to automatically generate a work site equipment grouping automatically associates work machines 20 connected on a near network to one or more work machines 20. In some embodiments, the automatic associations are based on rule stored on a work machine or on another network node. In some embodiments, the association rules are based on one or more of a work site designation, a location of a machine, or a code (e.g. a customer key, a manufacturer key, or a maintainer key).

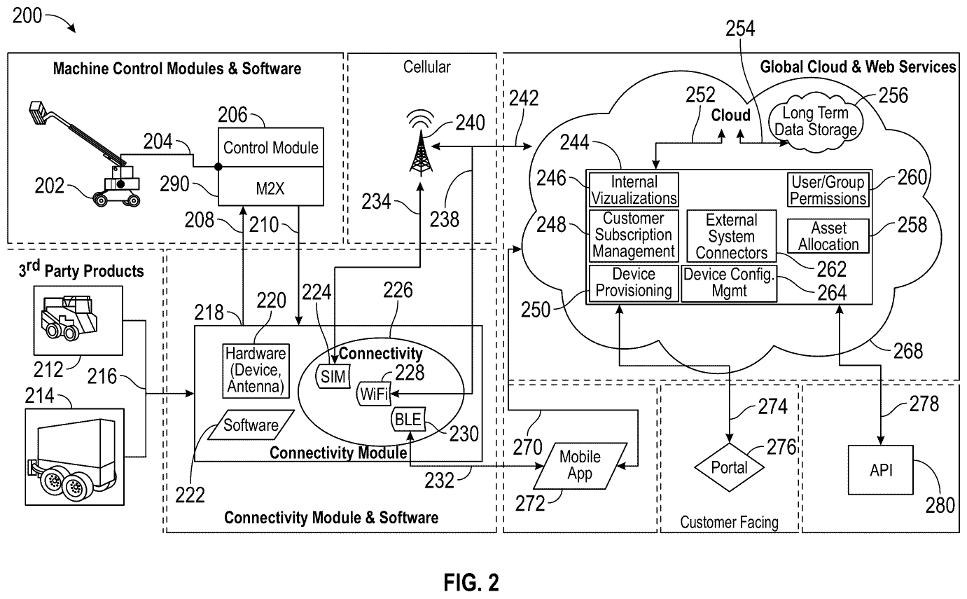

As shown in FIG. 2, the system for fleet connectivity system 200 is supported by a network of nodes. The network of nodes may include one or more work machines 202, each with a controller 206, one or more connectivity modules 218, and one or more network devices hosting, for example, user devices 272, network portals 276, application interfaces/application programming interfaces 280, data storage systems 256, cloud and web services, and product development tool and application hubs 244.

The work machine 202 is communicably connected to a controller 206. The connection between the work machine 202 and the controller 206 may be wired or wireless thus providing the flexibility to integrate the control module with the work machine 202 or to temporarily attach the controller 206 to the work machine 202. The controller 206 may be configured or may be reconfigurable in both hardware and software to interface with a variety of work machines 202, 212, 214 via the connectivity module 218. The controller 206 may comprise an integral power source or may draw power from the work machine 202 or another external source of power. Controllers 206 may be installed on or connected, e.g., via a connection 216, to products (e.g. third party work machines 212, 214) not configured by the original product manufacturer with a controller 206.

The work machine 202 communicably connects to the local fleet connectivity system 200 via a machine-to-X (M2X) module 290. The M2X module 290 is communicably connected to the controller 206. The M2X module 290 establishes one or more communications channels 208, 210 with a connectivity module 218. The connectivity module 218 provides a plurality of links between one or more work machines 202, 212, 214 and the local fleet connectivity system 200. Applications providing functions for the local fleet connectivity system 200 may be run by the M2X modules on one or more work machines 202 exchange commands, codes (e.g. a customer key) and data between work machines 202, 212, 214, and user devices 272, including user interfaces, to form a network of interconnections among machines, devices, or nodes. Connections between machines and user devices in the local fleet connectivity system may be provided by a wireless mesh network, for example.

The connectivity module 218 comprises hardware 220, further comprising antennas, switching circuits, filters, amplifiers, mixers, and other signal processing devices for a plurality of wavelengths, frequencies, etc., software hosted on a non-volatile memory components 222, and a communications manager 226. The communications manager 226 may comprise processing circuits with communications front ends 224, 228, and 230 for one or more signal formats and waveforms including, for example, Bluetooth, Bluetooth low energy, WiFi, cellular, optical, and satellite communications. The connectivity module 218 may function as a gateway device connecting work machine 202 to other work machines 212, 214, remote networks 244, 272, 276, and 280, beacons, scheduling or other fleet management and coordination systems.

The local fleet connectivity system 200 allows for the coordination of multiple work machines 202, 212, 214 within the same work site, or a fleet wide control. For example, a work machine 202 may remotely report the results of a self-inspection to a user via a user device 272 (e.g., including a user interface).

The local fleet connectivity system 200 provides connectivity between work machines 202, 212, 214 and user devices 272 (with user interfaces), network portals 276, application interfaces/application programming interfaces 280, data storage systems 256, cloud and web services 268, and product development tool and application hubs 244 that function as an Internet of Things (IoT) system for operation, control, and support of work machines 202, 212, 214 and users of work machines. Product development tool and application hubs 244 may comprise tools and applications for internal visualizations 246, customer subscription management 248, device provisioning 250, external systems connectors 262, device configuration management 264, user/group permissions 260, asset allocation 258, fleet management, compliance, etc. Further, connections 232, 234, 238, 242, 252, 254, 270, 274, and 278 between nodes connected to the local fleet connectivity system 200 may comprise, for example, cellular networks (e.g., via cell towers 240), or other existing or new means of digital connectivity, which may connect work machines 202, 212, 214 to other components of the local fleet connectivity system 200, as discussed below.

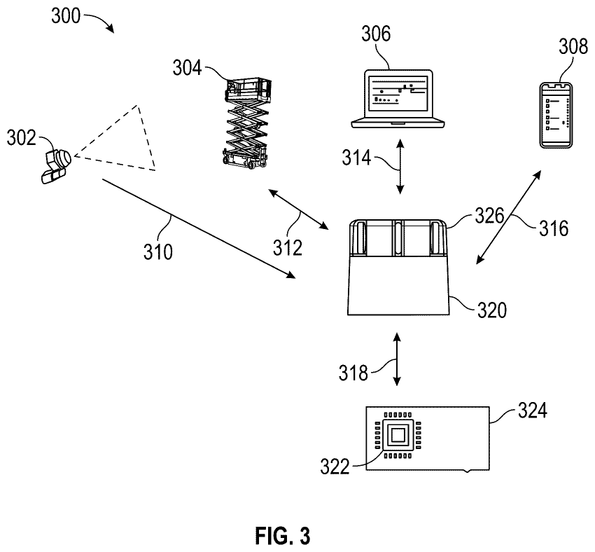

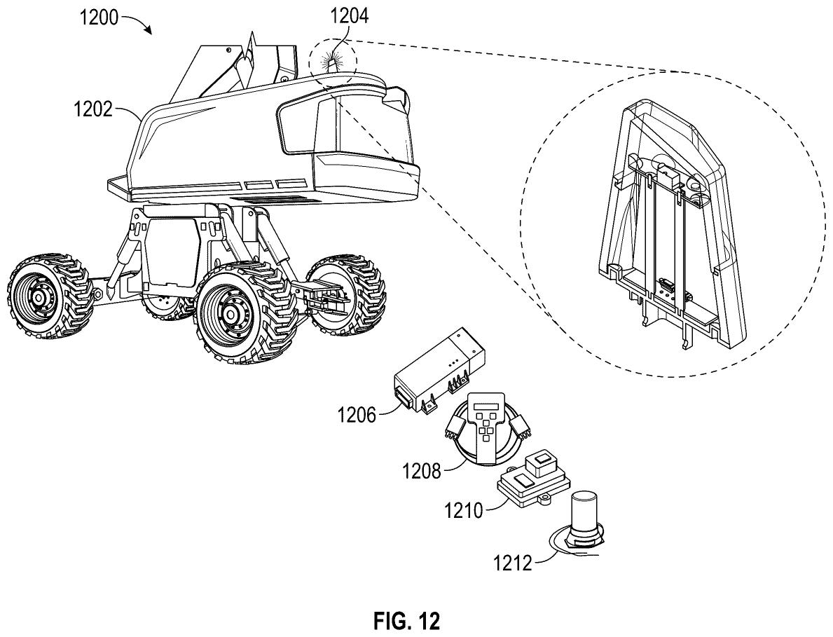

Referring still to FIG. 2, the connectivity module 218 is communicably connected to a work machine controller (e.g., controller 206), and may communicate between the work machine 202 and other components of the local fleet connectivity system 200. As will be discussed in greater detail below, in an exemplary embodiment the connectivity module 218 is integrated with an indicator (e.g., indicator 326 shown in FIG. 3, beacon 1212 shown in FIG. 12, etc.), which may be configured to provide an indication or signal that indicates a status of a machine. Also according to an exemplary embodiment, and as will be discussed in greater detail below, the connectivity module 218 may also be integrated with a telematics control unit, a multi-function indication system, one or more multi-channel communication modems, one or more analytics devices, one or more antennas, one or more power sources, one or more positioning systems, one or more local fleet connectivity processors, and one or more interface blocks, one or more machine connectivity provisions, one or more memory devices, and/or any other suitable component or device configured to connect components of the local fleet connectivity system 200. In this regard, the connectivity module 218 (e.g., with the integrated indicator 326, beacon 1212, etc.) may be configured to perform various functions, for example determine and provide an indication of a status of a machine, analyze and provide an indication relating to customer and/or commercial services, analyze and provide an indication relating to electronic services, analyze and provide an indication relating to machine configuration and location information, etc.

According to an exemplary embodiment, the connectivity module 218 is integrated with an indicator (e.g., indicator 326 shown in FIG. 3, beacon 1212 shown in FIG. 12, etc.), and is configured to communicate with the work machine 202, the user device 272, and/or components of the application hub 244 (e.g., internal visualizations 246). The connectivity module 218 may be configured to receive data from the work machine 202 that represents a state or condition of the work machine 202, for example in response to a status request from a user of the user device 272, a request from the cloud and web services 268, and/or as a result of predetermined functionality of components of the work machine 202 (e.g., the controller 206). In an exemplary embodiment, the connectivity module 218 is configured to store the data (e.g., via a memory, etc.). Further, the connectivity module 218 may be configured to provide an indication or signal (e.g., via the indicator 326, beacon 1212, etc.) that indicates a status of the machine. For example, the connectivity module 218 (e.g., indicator 326, beacon 1212, etc.) may provide a visual indication (e.g. colored lights, for example white, red, blue, green, orange, etc.; patterned lights, for example solid, flashing, strobed, etc.; a light having varied optical characteristics, for example wavelength, intensity, pulse duration, direction, etc.; and/or any other suitable visual indication system or device), an audible indication (e.g., a noise, alarm, warning, message, etc.), a tactile signal (e.g., vibration, etc.), and/or any other suitable indication or signal (e.g., a message to the user device 272, an icon on an application, a message to the internal visualizations 246, etc.). According to an exemplary embodiment, the indication represents a state, condition, or status of a machine. For example, the state or condition may include a fuel level of a machine, the status of a component of the machine (e.g., retracted, extended, open, closed, etc.), whether the machine is on or off, whether the machine is in operation or moving, a charge level of the machine, whether the machine is charging and/or charged, whether a machine requires a diagnostic check, a trouble shooting check, maintenance, DTC, characteristics of the machine (e.g., machine type, model, work site tag, etc.), etc. In an exemplary embodiment, the connectivity module 218 (via the indicator 326, beacon 1212, etc.) is configured to provide the status of a machine (e.g., via indicator 326, beacon 1212, etc.) to a user, observer, the user device 272, and/or the application hubs 244 (e.g., internal visualizations 246).

Also according to an exemplary embodiment, the connectivity module 218, with the integrated indicator (e.g., indicator 326, beacon 1212, etc.), is also configured to communicate with the user device 272 and/or another component of the application hub 244 (e.g., customer subscription management 248). In an exemplary embodiment, the connectivity module 218 is configured to support, send, receive, analyze, and/or store data relating to customer and/or commercial services, for example from the customer subscription management 248 hub the user device 272, and/or another suitable source. In an exemplary embodiment, the connectivity module 218 receives advertising, user preference identification, point of sale, third-party messaging, etc. data relating to a customer and/or commercial services. The connectivity module 218 (e.g., via the indicator 326, beacon 1212, etc.) may also be configured to process the data and/or provide an indication (e.g., a visual indication via a display, via an interface on the user device 272, etc.) to a user or observer. For example, the connectivity module 218 may provide an indication that represents a recommended purchase for a user or customer (e.g., based on a state or condition of the machine, as discussed above), a point of sale service (e.g., an order entry, payment acceptance, order tracking, customer subscription management, etc.), and/or any other suitable commercial service.

In some embodiments, the connectivity module 218, with the integrated indicator (e.g., indicator 326, beacon 1212, etc.), is also configured to communicate with the user device 272 and/or another component of the application hub 244 (e.g., the device provisioning 250). In an exemplary embodiment, the connectivity module 218 is configured to support, send, receive, analyze, and/or store data relating to setting up, provisioning, updating, and/or commissioning a machine, for example from the device provisioning 250 hub, the user device 272, and/or another suitable source. For example, the connectivity module 218 may receive technology manual, service manual, parts manual, regulatory guidance document, marketing flyer, etc. data relating to information that may be used in setting up, updating, and/or commissioning a work machine. The connectivity module 218 (e.g., via the indicator 326, beacon 1212, etc.) may also be configured to process the data and/or provide an indication (e.g., a visual indication via a display, via an interface on the user device 272, etc.) to a user or observer. For example, the connectivity module 218 may provide an indication that represents that maintenance is required, a service technician should be called, a machine is operating in violation of a technical and/or regulatory requirement, etc. In some embodiments, the connectivity module 218 is also configured to receive data relating to software and/or technical updates relating to a machine and components thereof, for example from the device provisioning 250 hub, the user device 272, and/or another suitable source. In this regard, the connectivity module 218 may be configured to facilitate more efficient machine commissioning and/or updates by providing an integrated system that receives, process, and analyzes data, as well as provides indications relating to the machine to users and/or observers.

In an exemplary embodiment, the connectivity module 218, with the integrated indicator (e.g., indicator 326, beacon 1212, etc.), is further configured to communicate with the work machine 202, the user device 272, and/or yet another component of the application hub 244 (e.g., device configuration management 264). The connectivity module 218 may be configured to receive data from the work machine 202 (e.g., a sensor, the controller 206, etc.) that represents one or more pressures of one or more components of the work machine 202. In an exemplary embodiment, the pressure data may be used to determine various characteristics, statuses, conditions, states, etc. of the work machine 202. For example, the connectivity module 218 may receive pressure data from components of the work machine 202 (e.g., the controller 206), and the connectivity module 218 (and/or the controller 206) may use the pressure data to determine a position of the work machine 202 on a floorplan of a work site, on a network (e.g., a mesh network), a position relative to the user device 272, other work machines 212, 214, etc. In some embodiments, the connectivity module receives pressure data relating to one or more components of the work machine 202 (e.g., the chassis, platform, forks, a load, an implement, work site hub device, etc.), and determines a relative height of the work machine 202, an operational height of a component of the work machine 202 (e.g., a fork, platform, etc.), completes a safety check, performs an elevation verification and/or calculation, etc. The connectivity module 218 (e.g., via the indicator 326, beacon 1212, etc.) may also be configured to provide an indication (e.g., a visual indication, via an interface on the user device 272, etc.) relating to the positioning and/or configuration of the work machine 202 to a user or observer. For example, the connectivity module 218 may provide an indication that represents that a component of the work machine 202 is an unsafe height, the work machine 202 requires maintenance, etc. Although the connectivity module 218 is described herein as receiving data that represents one or more pressures, it is understood that any data may be received that relates to the positioning, orientation, and/or characteristics of the work machine 202 (e.g., temperature, speed, light, etc.).

In other embodiments, the connectivity module 218, with the integrated indicator (e.g., indicator 326, beacon 1212, etc.), is further configured to communicate with the user device 272, and/or yet another component of the application hub 244 (e.g., asset allocation 258). The connectivity module 218 may be configured to support, send, receive, analyze, and/or store data relating to electronic commerce services, for example from the asset allocation 258 hub, the user device 272, and/or another suitable source. In an exemplary embodiment, the connectivity module 218 receives original equipment manufacturer advertising (e.g. service kit, equipment consumable, replacement parts based on a status or condition of a machine, etc.), third party advertising, point of sale, etc. data relating to the commerce services of the work machine 202. The connectivity module 218 (e.g., via the indicator 326, beacon 1212, etc.) may also be configured to process the data and/or provide an indication (e.g., a visual indication via a display, via an interface on the user device 272, etc.) to a user or observer. For example, the connectivity module 218 may provide an indication that indicates a machine component in need of replacement (e.g., via a status indication, as discussed above), a sales channel that supports a sale, a local sales team that supplies the component in need of replacement, etc.

As will be discussed in greater detail below, the connectivity module 218 (e.g., with the integrated indicator 326, beacon 1212, etc.) may be configured to perform various functions, for example determine and provide an indication of a status of a machine, analyze and provide an indication relating to customer and/or commercial services, analyze and provide an indication relating to electronic services, analyze and provide an indication relating to machine configuration and location information, control one or more components of a work machine based on a criteria of the work machine, etc. While the connectivity module 218 is described herein as performing certain functions, it is understood that the connectivity module 218 may perform different and/or similar functions using additional, fewer, and/or different working components.

Referring now to FIG. 3, a fleet connectivity system 300 is shown, according to an exemplary embodiment. In some embodiments, components of the fleet connectivity system 300 are integrated and/or combined with components of the fleet connectivity system 200 of FIG. 2. As shown in FIG. 3, a connectivity module 320 functions as a communications interface between a work machine 324 (e.g., a control system) and other components connected to the fleet connectivity system 300. As discussed above, the connectivity module 320 is integrated with an the indicator 326, which may be beacon, light, display, and/or any other suitable device and/or system configured to provide an indication. In an exemplary embodiment, the connectivity module 320 is configured to exchange data with various components of the fleet connectivity system 300 (e.g., via wireless connection, Bluetooth, etc.). For example, the connectivity module 320 may exchange data 318 with a control system 322 of the work machine 324, data 316 with a user device 308 running an application for the fleet connectivity system 300, data 314 with a node or portal 306, data 312 with another work machine 304, sensor data 310 with auxiliary sensors 302, data with a connectivity hub configured to connect a plurality of machines to the fleet connectivity system 300, and/or any other suitable commands and/or data with another suitable working device or machine.

As shown in FIG. 3, the connectivity module 320 is integrated with the indicator 326, which is configured to provide an indication or signal to an observer. According to an exemplary embodiment, the indicator 326 is integrated with the connectivity module 320 and/or provides an indication as a mode of the fleet connectivity system 300; however, in other embodiments the indicator 326 is integrated with another component of the fleet connectivity system 300 and/or the work machine 324 (e.g., a vehicle external light, a vehicle internal light, a headlight, taillight, beacon, horn, etc.). In an exemplary embodiment, the indicator 326 is a visual indication device, for example a light (e.g. an incandescent light, a light emitting diode, a fixed beacon, a flashing beacon, a rotating beacon, a laser, a light array, etc.), a display device, a marker, etc. However, in other embodiments the indicator 326 incorporates other indications (e.g., an audible, tactile, electronic, etc. indication), which may be used in conjunction or independently of the visual indication. The indication may relate to a status of the work machine 324 (e.g., power on, power off, in operation, fuel level, electrical system state of charge, DTC, maintenance required, etc.).

According to an exemplary embodiment, the indicator 326 is configured to generate a variety of indications and/or signals, for example visual, audible, tactile, etc. signals. In some embodiments, the indications comprise one or more colors, patterns, and/or combinations of colors and patterns. The indicator 326 may generate visual signals observable as a light or one or more light patterns. In some embodiments, the light patterns generated by the indicator 326 are varied in any optical characteristic (e.g. color, wavelength, intensity, pulse duration, direction, etc.). In other embodiments, the indicator 326 is configured to generate an audible indicator (e.g., a noise, alarm, warning, message, etc.), a tactile signal (e.g., vibration, etc.), and/or any other suitable indicator or signal (e.g., a message to a user device, an icon on an application, etc.).

In an exemplary embodiment, the indications generated by the indicator 326 relate to various states, conditions, statuses, and/or criteria of the machine. For example, the indications may indicate that one or more machines on a work site that have sufficient fuel levels to perform a task. In other embodiments, the indications indicate predefined or user configurable machine states for a local identification of that state. For example, a work machine 324 can flash a beacon light indicating that it requires a charge. In some embodiments, the indication may be initiated in response to data 316 entered by a user at a user device 308, entered at the node or portal 306, a machine to machine command (e.g., another work machine 304), as a result of communication from the connectivity hub, etc.

According to an exemplary embodiment, the indicator 326 is configurable to function when work machine 324 is off (e.g., powered off, out of battery, out of fuel, etc.). The indicator 326 may be configured to receive input (e.g., sensor input from the work machine 324, user input from the user device 308, fleet input from the connectivity hub, etc.) via a Bluetooth low energy (BLE) signal received at the connectivity module 320. The BLE communications path can be configured to remain active with power input from another power source (e.g. a battery, etc.). In some embodiments, the BLE communications channel in the connectivity module 320 remains open, and the indicator 326 is available to display a signal in a power saving mode (e.g. modified receiver duty cycles, reduced communications/BLE intervals, lower power operation of the indicator 326, etc.).

As discussed above, in some embodiments onboard sensors detect a state or condition of the work machine 324. The control system 322 may provide data 318 to the connectivity module 320, and/or directly to the indicator 326, such that the indicator 326 may provide an indication representing a detected status of the work machine 324. In some embodiments, the indicator 326 illuminates a colored light to provide a signal corresponding to a selected machine status. For example, a work site supervisor may select green to indicate a fuel level above ¾ of capacity, yellow to indicate a fuel level between ¾ and ¼, and red to indicate a fuel level below ¼. In addition, a service technician may transmit a wireless command to all machines on a work site to flash a red light if the control system 322 determines a battery charge below a specified level.

Also as discussed above, in some embodiments the user device 308 hosts an application that allows a user to receive an indication (e.g., via a user interface, etc.). In an exemplary embodiment, a user selects a criterion for a machine status and a visual indicator corresponding to the criterion via the application. For example, a user may selects state of charge as a criterion for electric powered scissor lift machines (e.g., the other work machine 304) on a work site, and one or more state visual indicator signals (e.g. a colored light) corresponding to one or more state of charge conditions. The user input may be transmitted to work machines 304, 324 via a network, which may be received by the connectivity module 320 (and/or the integrated indicator 326). The connectivity module 320 (and/or the indicator 326) may process the input, determine a status of the other work machine 304, and/or provide an indication relating to the status of the machine. For example, each indicator 326 of the machines at the work site may display a light beacon with a color representing a status of that machine (e.g., machines with good charges show green lights, machines requiring a recharge show yellow lights, and machines requiring battery replacement show red lights.).

In some embodiments, components of the fleet connectivity system 300 (e.g., the user device 308 and/or the application, etc.) are also configured to support fleet identification functions. For example, one or more applications (e.g., on the connectivity module 320 with the integrated indicator 326, the user device 308, etc.) may be configured to receive, store, process, and/or provide machine status data and/or indications relating to one or more machines in a fleet. The one or more machines in a fleet may be communicably connected (e.g. directly using a mesh, WiFi, or other local connection or remotely via a cloud network connection), so as to communicate with components of the fleet connectivity system 300, as discussed above. Further, in an exemplary embodiment the one or more work machines (e.g., the work machine 324, the other work machine 304) are each configured with a connectivity module 320 (and an indicator 326). According to an exemplary embodiment, a user selects a desired machine status in the application (e.g., on the user device 308 via a “find me” application), and the user input is transmitted to the work machines 304, 324 (e.g., the connectivity modules 320) in the fleet. Each work machine in the fleet may process the input, determine the status of the machine, and/or provide an indication of the status of the machine (e.g., simultaneously), as discussed above. According to an exemplary embodiment, the connectivity modules 320 (e.g., the indicators 326) may provide an indication (e.g., lights, horns, etc.) to allow a user to distinguish the statues of machines and/or identify machines of suitable status quickly. Further, the connectivity modules 320 (e.g., the indicators 326) may also provide an indication to the application, which may be presented to the user in a graphical user interface (e.g., a digital map, etc.) in order to allow a user to observe the statuses of a group of machines at a work site via the user device 308. In some embodiments, the user may select (e.g., via the graphical user interface of the user device 308) a digital representation of the work machine in the digital map, and control and/or observe condition of the work machine. Further, a user may selectively filter the condition, states, statues, and/or criteria of the desired work machines in a fleet in the application, for example via machine states (fully charged, at least ½ fuel, no outstanding service issues, no faults detected on self-test, etc.), machine type (e.g. specific make, specific model, etc.), machine location (e.g. proximity to the user, proximity to a task, positioned for easiest movement out of a staging area, etc.), and/or any other suitable criteria. According to an exemplary embodiment, the connectivity modules 320, the indicators 326, the control systems 322 and/or the application may store the data relating to each status request and/or user input (e.g., including machine serial numbers, service records, machine location, electronic commerce data, use tracking data, billing data, maintenance support data, etc.).

In some embodiments, components of the fleet connectivity system 300 (e.g., the user device 308 and/or the application, etc.) are also configured to support commercial services, as discussed above. For example, one or more hosted applications (e.g., on one or more processors, the control system 322, the connectivity module 320 with the integrated indicator 326, the user device 308, etc.) may be configured to receive, store, process, and/or provide advertising, user preference identification, point of sale, third-party messaging, etc. data and/or indications. In an exemplary embodiment, the connectivity module 320 (and/or the indicator 326) is configured to provide an indication relating to commercial services to the application, such that the application may generate user interfaces having icons or messages (e.g., via the user device 308, a display, etc.), one or more of audio, visual, and/or tactile signals to convey messages, and/or any other suitable indication. For example, the application may display recommended purchases to the user based on a machine status connected to the fleet connectivity system 300, a parameter (e.g., a machine price, etc.) associated with a machine of the fleet connectivity system 300, a point of sale service (e.g. order entry, payment acceptance, order tracking, etc.), of the fleet connectivity system 300, etc.

In other embodiments, components of the fleet connectivity system 300 (e.g., the user device 308 and/or the application, etc.) are also configured to support commerce functions, as discussed above. For example, one or more applications (e.g., on the connectivity module 320 with the integrated indicator 326, the user device 308, etc.) may be configured to receive, store, process, and/or provide original equipment manufacturer advertising (e.g., service kit, equipment consumable, replacement parts based on a status or condition of a machine, etc.) data and/or indications. In an exemplary embodiment, the connectivity module 320 (and/or the indicator 326) is configured to provide an indication relating to commerce functions to the application. For example, the connectivity module 320 (and/or the indicator 326) may provide an indication (e.g., message) based on a specific machine or machines being accessed, a profile or a nature of a person accessing the specific machine or machines, weather or local conditions around the machine or machines, conditions or states associated with the machine (e.g., engine hours, fault codes, etc.), location of the machine, location of the work site, proximity of a vendor to a work site, etc. In other embodiments, the connectivity module 320 (and/or the indicator 326) may provide indications (e.g., messages) that include a point of sale interface (e.g., portal) that allows an original equipment manufacturer (OEM) to determine a component that needs to be replaced (e.g., based on the status of the component determined via sensors, as discussed above). Further, the connectivity module 320 (and/or the indicator 326) may provide indications (e.g., messages, interfaces, etc.) that allow an OEM to locate the nearest replacement part, determine a price and delivery time for the part, provide a message to a user on the user device 308 identifying the need to replace the component, the price and arrival time for the replacement component, a purchase incentive for ordering the component through the application, process the order through the user device, and/or provide post sale services (e.g. delivery status, installation instructions, warranty support) through the application.

In yet other embodiments, components of the fleet connectivity system 300 (e.g., the user device 308 and/or the application, etc.) are also configured to support additional commerce functions, as discussed above. For example, one or more applications (e.g., on the connectivity module 320 with the integrated indicator 326, the user device 308, etc.) may be configured to receive, store, process, and/or provide third party advertising, point of sale, etc. data and/or indications. In an exemplary embodiment, the connectivity module 320 (and/or the indicator 326) is configured to provide an indication relating to a number of users present at a work site, a time of day, a purchase incentive from a vendor, user preferences, etc. Further, the connectivity module 320 (and/or the indicator 326) may be configured to provide indications that capture a record of sales conversions in response to electronic messaging as a basis for revenue calculation for a sales channel.

As discussed above, in some embodiments the connectivity module 320 and/or the indicator 326 are configured to receive pressure data relating to one or more components of the work machine 324. In an exemplary embodiment, the connectivity module 320 and/or the indicator 326 is configured to receive pressure data from the control system 322, determine various statuses, parameters, characteristics, etc. relating to the work machine 324, and/or provide an indication relating to the determined statuses or characteristics of the work machine 324 or components thereof. For example, the connectivity module 320 may receive pressure data relating to the chassis, platform, forks, a load, etc. of the work machine 324. Based on the data, the connectivity module 320 (and/or the control system 322) may determine a relative pressure difference between components of the work machine 324, a relative position and/or orientation of the components (e.g., height, elevation, etc.), a the position of the work machine 324 with respect to a floorplan of a work site, a network (e.g. a mesh network), the user device 308, and/or another machine 304, etc. In some embodiments, the connectivity module 320 (and/or the control system 322) is configured to determine an operational height of the work machine 324 or components thereof, a current state (e.g., height elevation, etc.) of components of the work machine 324, for example a platform. The connectivity module 320 (and/or the indicator 326) may also provide an indication relating to the determined position and/or orientation of the work machine 324 and/or components thereof. For example, the connectivity module 320 may provide an elevation indication, a component height warning, a verified height calculation, a safety check status, a height safety indication, etc. As shown in FIG. 3, in some embodiments the connectivity module 320 and/or the indicator 326 are configured to receive sensor data from onboard sensors (e.g., on the work machine 324) and/or off board sensors (e.g., sensors not located on the work machine, the auxiliary sensors 302, on the user device 308, a work site hub device, etc.).

As will be discussed in greater detail below, the connectivity module 320 (e.g., with the integrated indicator 326) may incorporate various components that allow the integrated connectivity module 320 and/or indicator 326 to perform various functions required by the fleet connectivity system 300 (e.g. GPS sensor, GPS antenna, Bluetooth transmitter, Bluetooth antenna, WiFi module, WiFi antenna, cellular data transmitter, cellular data antenna, pressure transducer, light sensor, accelerometer/inertial measurement unit, memory storage, processor, multiple colored LEDs, etc.). For example, the connectivity module 320 and/or indicator 326 may include components configured to determine and provide an indication of a status of a machine, analyze and provide an indication relating to customer and/or commercial services, analyze and provide an indication relating to electronic services, analyze and provide an indication relating to machine configuration and location information, receive and store data and software (e.g., for over-the-air software updates, storing technical and/or service manuals, storing advertising files, etc.), control one or more components of a work machine based on a criteria, etc. While the connectivity module 320 is described herein as performing certain functions, it is understood that the connectivity module 320 may perform different and/or similar functions using additional, fewer, and/or different working components.

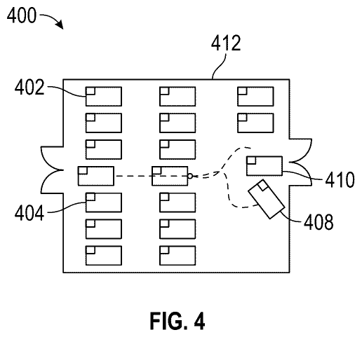

Referring now to FIG. 4, a fleet connectivity system 400 is shown, according to an exemplary embodiment. As discussed above, the fleet connectivity system 400 may be deployed at a work site 412 to control a fleet of work machines 402, 404, 408, 410, so as to collaboratively perform tasks requiring more than one work machine 408, 410. For example, a user may wish to move the work machine 410 from its stored position on the left of the work site 412 out the door on the right of the work site. Components of the fleet connectivity system 400 (e.g., a network access point, a system access point, a connectivity hub, work machines having a connectivity module, etc.) may communicate with both the work machine 408 and the work machine 410, causing the work machine 408 to move out of the way of the work machine 410, so that the work machine 410 can move past the work machine 408 and out the doorway.

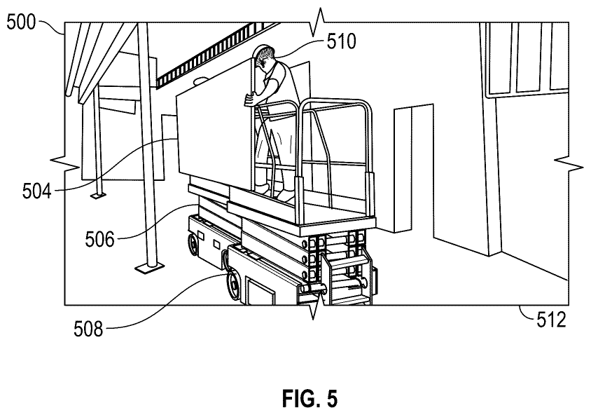

Referring now to FIG. 5, a fleet connectivity system 500 is shown, according to an exemplary embodiment. As discussed above, the fleet connectivity system 500 may be communicably coupled to a plurality of work machines 506, 508 (e.g., via a plurality of connectivity modules), such that the work machines 506, 508 may collaboratively perform tasks on a jobsite 512. For example, as shown in FIG. 5 the fleet connectivity system 500 may be used to replace a section of drywall 504 that is too large to be handled by a single work machine 508. Components of the fleet connectivity system 500 (e.g., a network access point, a system access point, a connectivity hub, etc.) may communicate with both the work machine 506 and the work machine 508, and cause them to move at the same speed and in the same direction so that a user 510 on each work machine 506, 508 may hold the drywall 504 while the work machines 506, 508 are moving. In this regard, communication between components of the fleet connectivity system and the work machines 506, 508 may prevent the work machines 506, 508 from being separated so that the users 510 do not drop the drywall 504

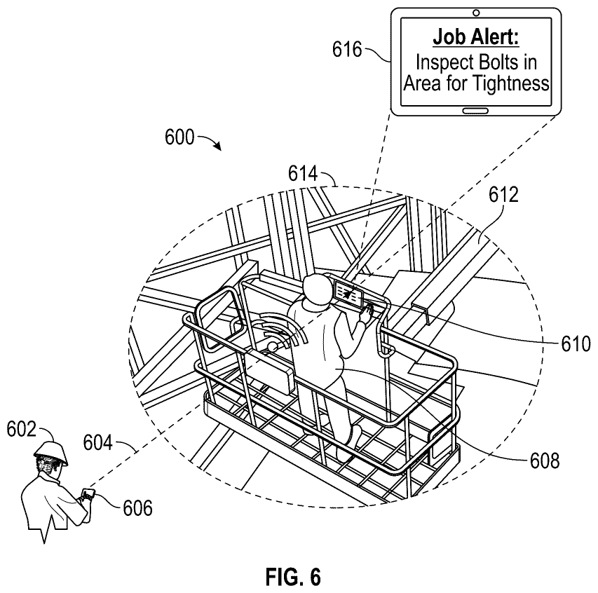

Referring now to FIG. 6, a remote user 602 of a fleet connectivity system 600 can send messages and data 604 from a remote device 606 to an onsite user 608 on a jobsite 614. The messages and data 604 may be received by the control system 610 of a work machine 612 and displayed via a user interface on an onboard display 616. The remote device 606 may send work instructions to the onsite user 608, informing the onsite user 608 of talks to be performed using the work machine 612. For example, as shown in FIG. 6, the remote user 602 may send instructions to the onsite user 608 to use the work machine 612 to inspect bolt tightness in the area. The instructions may displayed for the onsite user 608 on the onboard display 616. This allows the onsite user 608 to receive and view the instructions without the need to call the remote user 602 or write the instructions down. Because the work machine 612 is connected to the remote device 606 (e.g., via a connectivity module 218) the remote user 602 may receive the location of the work machine 612, as well as other work machines on the jobsite 614, and may use the location information to determine the instructions to send.

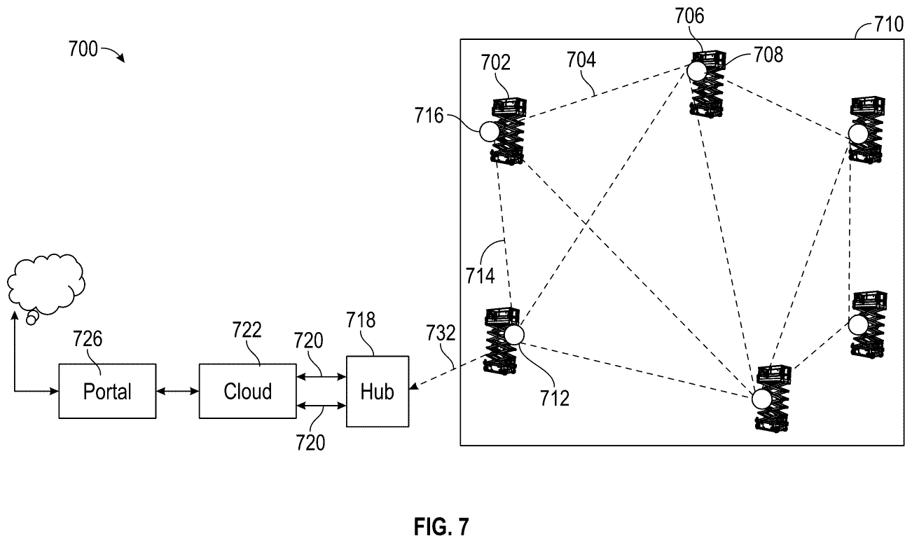

Referring to FIG. 7, a fleet connectivity network system 700 includes a connectivity hub 718. In some embodiments, the connectivity hub 718 includes and/or communications with a connectivity module. In some embodiments, the connectivity hub is configured to communicatively connect with one or more connectivity module equipped machines (e.g., work machines 702, 706) in proximity to the connectivity hub 718. In some embodiments, the connectivity hub is configured to broadcast a work site identification signal. In some embodiments, the connectivity hub is configured to connect work machines 702, 706 connected to the local fleet network to an external internet feed. In some configurations, the connectivity hub 718 is configured as a gateway to one or more communications systems or network systems to enable exchanges of data 720, 722 between nodes 708, 712, 716 on the work site 710 local fleet connectivity mesh network 704, 714, 732 and nodes 726 external to the work site. In some embodiments, connectivity hub has a connectively module that (a) provides the functionalities described here in place of or in addition to a machine that has a connectivity module, (b) broadcasts a site identifier, and/or (c) connects to an external internet to flow through data to and from the jobsite that is provided across the mesh.

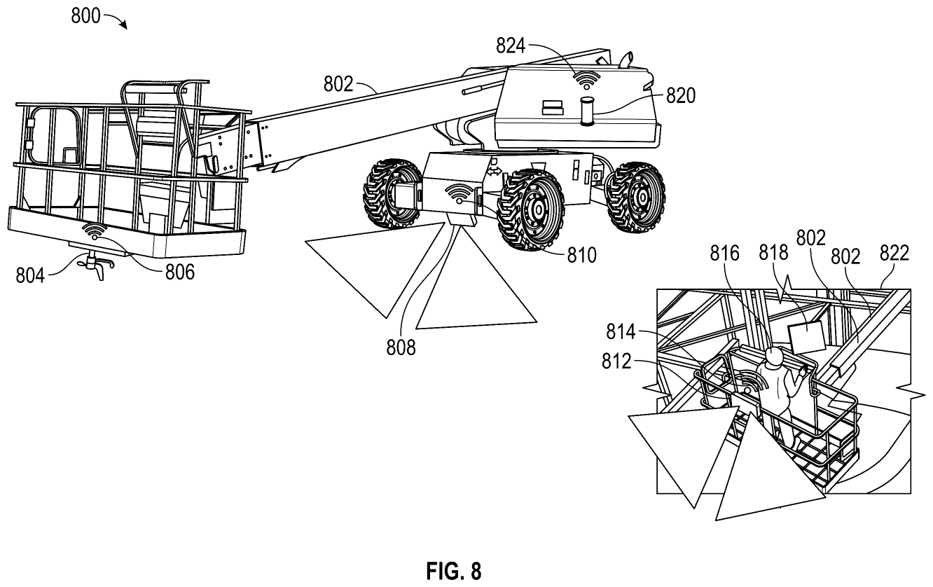

Referring to FIG. 8, a sensor network system 800 is shown. Sensors 804, 808, 812, 820 may be coupled to a work machine 802 on a jobsite 822. The sensors may be, for example, object detection sensors 808 812, environmental sensors 804 (e.g., wind speed, temperature sensors), and tagged consumable sensors 820. The sensors 804, 808, 812, 820 may be connected to and may send data to a fleet connectivity system via wireless connections 806, 810, 814, 824. The sensor data may be displayed or may be used to generate messages for display on an onboard display 818 for a user 816 of the work machine 802. The onboard display 818 may receive the sensor data via a direct wired or wireless connection to the sensors. Alternatively the sensors may communicate with the onboard display through the fleet connectivity system (e.g., via a connectivity module 218). Sensor data from various work machines may be combined to map the jobsite 822, and to determine if environmental conditions are safe for using the work machines. Sensor data from the tagged consumable sensors 820 may be used to determine, for example, when tagged consumables must be replaced.

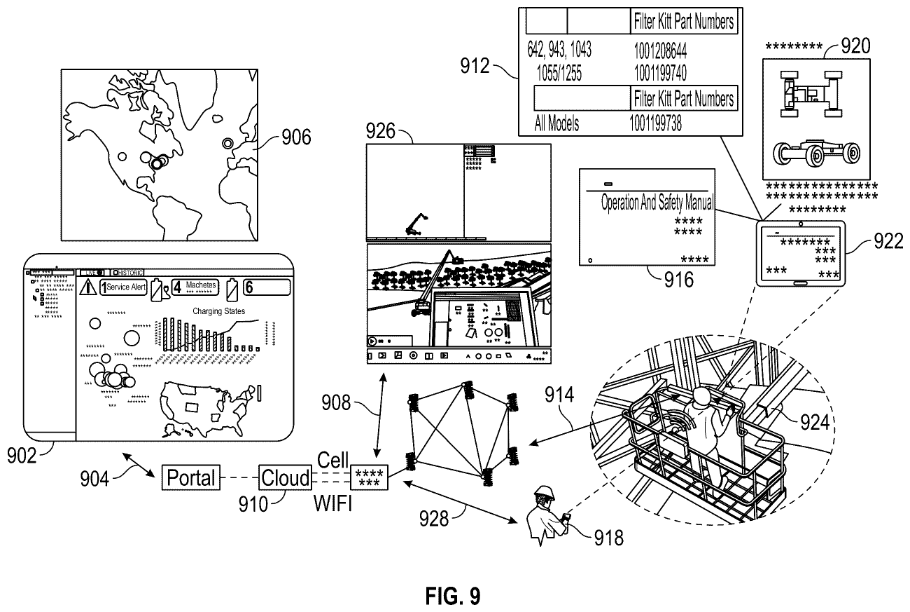

As shown in FIG. 9, various user interfaces are available to be displayed on a remote user device 918 and an onboard display 922 of a work machine 924. A connectivity hub 910 may send and receive data 928, 908, 904 914 including the user interfaces 902, 906, 912, 916, 926, 920. The user interface 906 is a heatmap of locations of a plurality of work machines. The user interface 902 is a machine status display that shows the battery level, location, and alerts relating to a plurality of work machines. User interface 926 shows a digital twin of a work machine that updates based on sensor data of an associated work machine. User interface 912 is a list of part numbers for the work machine 924. User interface 916 is an operation and safety manual for the work machine 924. User interface 920 is a detailed schematic of the work machine 924.

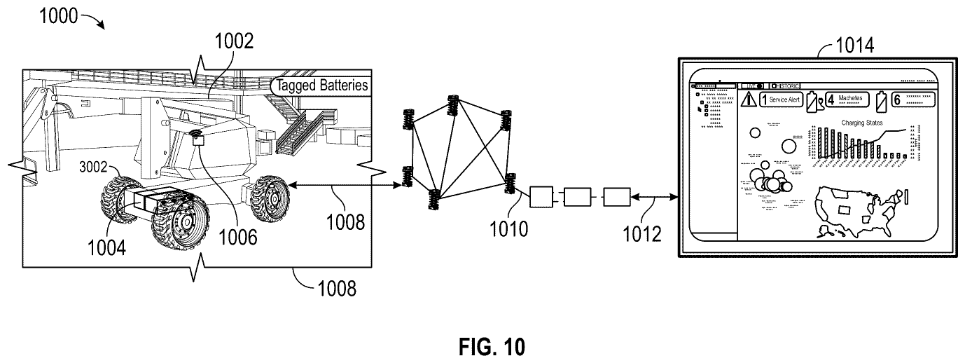

As shown in FIG. 10, a tagged consumable tracking system 1000 is shown. A work machine 1002 on a jobsite 1008 includes tagged consumables 1004 (e.g., batteries connected to battery charger 1006). The work machine 1002 sends and receives data 1012 to and from a connectivity hub 1010. The connectivity hub 1010 sends and receives data 1012 to and from a user interface 1014. Data regarding the tagged consumables 1004 may be communicated to the user interface 1014 via the connectivity hub 1010. For example, battery charge state and battery health may be sent to the user interface 1014. When the battery health falls below a predetermined state, for example, when the battery is only able to hold half of its original charge, the connectivity hub 1010 may send an alert to the user interface 1014 indicating that the battery should be replaced.

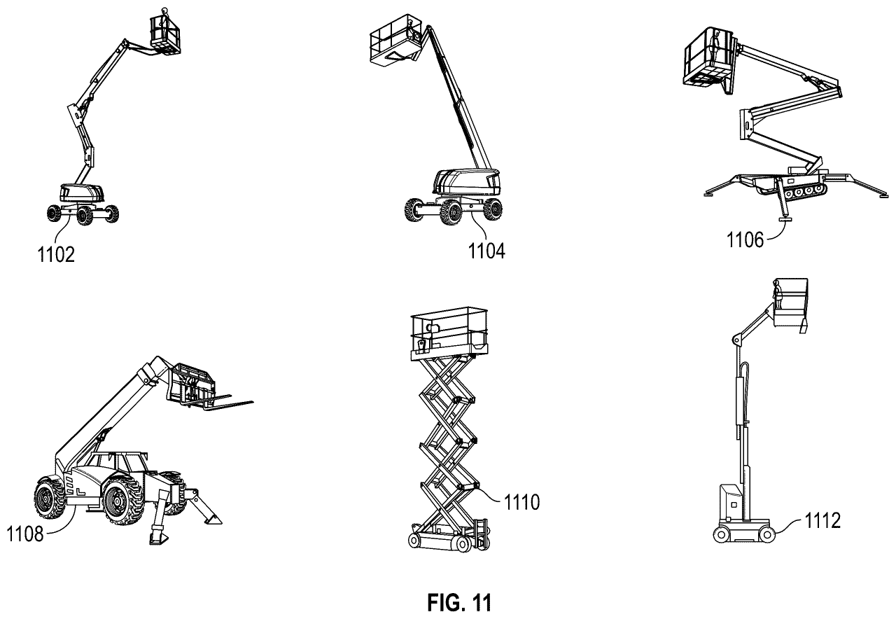

Referring now to in FIG. 11, the fleet connectivity network systems described above may be implemented using various work machines 20 (e.g., lift devices, etc.). For example, and as shown in FIG. 11, the fleet connectivity systems may be implemented as an articulating boom lift 1102, a telescoping boom lift 1104, a compact crawler boom lift 1106, a telehandler 1108, a scissor lift 1110 (and/or 506, 508 as shown in FIG. 5), and/or a toucan mast boom lift 1112.

According to the exemplary embodiment shown in FIG. 11, the work machines 20 (e.g., a lift devices, articulating boom lift 1102, telescoping boom lift 1104, compact crawler boom lift 1106, telehandler 1108, scissor lift 1110, toucan mast boom lift 1112) include various working components. As an illustrative example, the articulating boom lift 1102 may include a chassis (e.g., a lift base), which supports a rotatable structure (e.g., a turntable, etc.) and a boom assembly (e.g., boom). According to an exemplary embodiment, the turntable is rotatable relative to the lift base. According to an exemplary embodiment, the turntable includes a counterweight positioned at a rear of the turntable. In other embodiments, the counterweight is otherwise positioned and/or at least a portion of the weight thereof is otherwise distributed throughout the work machines 20 (e.g., on the lift base, on a portion of the boom, etc.). As shown in FIG. 11, a first end (e.g., front end) of the lift base is supported by a first plurality of tractive elements (e.g., wheels, etc.), and an opposing second end (e.g., rear end) of the lift base is supported by a second plurality of tractive elements (e.g., wheels). According to the exemplary embodiment, the front tractive elements and the rear tractive elements include wheels; however, in other embodiments the tractive elements include a track element.

In an exemplary embodiment, the boom includes a first boom section (e.g., lower boom, etc.) and a second boom section (e.g., upper boom, etc.). In other embodiments, the boom includes a different number and/or arrangement of boom sections (e.g., one, three, etc.). According to an exemplary embodiment, the boom is an articulating boom assembly. In one embodiment, the upper boom is shorter in length than lower boom. In other embodiments, the upper boom is longer in length than the lower boom. According to another exemplary embodiment, the boom is a telescopic, articulating boom assembly. By way of example, the upper boom and/or the lower boom may include a plurality of telescoping boom sections that are configured to extend and retract along a longitudinal centerline thereof to selectively increase and decrease a length of the boom.

In an exemplary embodiment, the lower boom has a first end (e.g., base end, etc.) and an opposing second end (e.g., intermediate end). According to an exemplary embodiment, the base end of the lower boom is pivotally coupled (e.g., pinned, etc.) to the turntable at a joint (e.g., lower boom pivot, etc.). In some embodiments, the boom includes a first actuator (e.g., pneumatic cylinder, electric actuator, hydraulic cylinder, etc.), which has a first end coupled to the turntable and an opposing second end coupled to the lower boom. According to an exemplary embodiment, the first actuator is positioned to raise and lower the lower boom relative to the turntable about the lower boom pivot.

In an exemplary embodiment, the upper boom has a first end (e.g., intermediate end, etc.), and an opposing second end (e.g., implement end, etc.). According to an exemplary embodiment, the intermediate end of the upper boom is pivotally coupled (e.g., pinned, etc.) to the intermediate end of the lower boom at a joint (e.g., upper boom pivot, etc.). As shown in FIG. 11, the boom includes an implement (e.g., platform assembly) coupled to the implement end of the upper boom with an extension arm (e.g., jib arm, etc.). In some embodiments, the jib arm is configured to facilitate pivoting the platform assembly about a lateral axis (e.g., pivot the platform assembly up and down, etc.). In some embodiments, the jib arm is configured to facilitate pivoting the platform assembly about a vertical axis (e.g., pivot the platform assembly left and right, etc.). In some embodiments, the jib arm is configured to facilitate extending and retracting the platform assembly relative to the implement end of the upper boom. As shown in FIG. 11, the boom includes a second actuator (e.g., pneumatic cylinder, electric actuator, hydraulic cylinder, etc.). According to an exemplary embodiment, the second actuator is positioned to actuate (e.g., lift, rotate, elevate, etc.) the upper boom and the platform assembly relative to the lower boom about the upper boom pivot.

According to an exemplary embodiment, the platform assembly is a structure that is particularly configured to support one or more workers. In some embodiments, the platform assembly includes an accessory or tool configured for use by a worker. Such tools may include pneumatic tools (e.g., impact wrench, airbrush, nail gun, ratchet, etc.), plasma cutters, welders, spotlights, etc. In some embodiments, the platform assembly includes a control panel to control operation of the work machines 20 (e.g., the turntable, the boom, etc.) from the platform assembly. In other embodiments, the platform assembly includes or is replaced with an accessory and/or tool (e.g., forklift forks, etc.).

Referring to FIG. 12, a work machine with a connectivity module with an integrated beacon is shown, according to an exemplary embodiment. According to an exemplary embodiment, the work machine 1202 is configured to be integrated with, and communicate with components of, a fleet connectivity system (e.g., the fleet connectivity system 200, the fleet connectivity system 300, the fleet connectivity system 400, the fleet connectivity system 500, the fleet connectivity network system 700, and/or any combination thereof, etc.). In some embodiments, the connectivity module is the connectivity module 218 of FIG. 2, the connectivity module 320 of FIG. 3, and/or any other suitable connectivity module. The beacon may be the indicator 326 of FIG. 3, and/or another suitable indication system or device configured to provide an indication to a user and/or observer, as discussed above.

As shown in FIG. 12, the work machine 1202 is provisioned with a connectivity module 1204, and is communicably coupled to components of a fleet connectivity system (e.g., the fleet connectivity system 200 of FIG. 2, the fleet connectivity system 300 of FIG. 3, etc.). The connectivity module 1204 is shown to include a telematics control unit 1206, one or more analytics devices (i.e., shown as analyzer 1208), one or more multi-channel communication modems (i.e., shown as communication modem 1210), and a multi-function beacon (i.e., shown as beacon 1212). According to an exemplary embodiment, the telematics control unit 1206 is configured to receive and/or communicate data relating to conditions, states, statuses, etc. of the work machine 1202 (e.g., via sensors, processors, etc.). For example, the telematics control unit 1206 may receive data relating to a fuel level, the status of a component of the work machine 1202 (e.g., retracted, extended, open, closed, etc.), whether the work machine 1202 is on or off, whether the work machine 1202 is in operation or moving, a charge level of the work machine 1202, whether the work machine 1202 is charging and/or charged, whether the work machine 1202 requires a diagnostic check, a trouble shooting check, maintenance, DTC, characteristics of the work machine 1202 (e.g., machine type, model, work site tag, etc.), etc. In some embodiments, the telematics control unit 1206 is configured to receive and/or communicate data relating to customer and/or commercial services, provisioning and/or updating the work machine 1202, pressures and/or positioning of one or more components of the work machine 1202, electronic commerce services, etc., as discussed above. In other embodiments, the telematics control unit 1206 is configured to control one or more components of the work machine 1202, for example based on a criteria relating to the work machine 1202 (e.g., a status, customer and/or commercial services, updates, pressure and/or positioning data, etc.). Further, the analyzer 1208 may be configured to receive (e.g., via the telematics control unit 1206) and/or analyze data relating to conditions, states, statuses, etc. of the work machine 1202. For example, the analyzer 1208 may be configured to receive data relating to and/or determine a fuel level of a machine, a status of a component of a machine, a charge level of a machine, whether a machine is on or off, whether a machine is moving, whether a machine needs a diagnostic check, maintenance, etc.

According to an exemplary embodiment, the communication modem 1210 is configured to receive and/or communicate data relating to conditions, states, statuses, etc. of the work machine 1202 (e.g., to components of the fleet connectivity system 200 of FIG. 2). For example, the communication modem 1210 may communicate a fuel level of the work machine 1202 to an application (e.g., on the user device 272), communicate information relating to customer and/or commercial services to an application (e.g., on the user device 272) or a hub (e.g., the customer subscription management 248 hub), communicate information relating to provisioning and/or updating the work machine 1202 to an application or a hub (e.g., the device provisioning 250 hub). Further, the communication modem 1210 may communicate information relating to pressures and/or positioning of one or more components of the work machine 1202 to an application (e.g., on the user device 272), communicate information relating to electronic commerce services to an application (e.g., on the user device 272) or a hub (e.g., the asset allocation 258 hub), and/or communicate any other suitable information relating to a condition, state, status, etc. of the work machine 1202. The beacon 1212 may be configured to receive and/or provide an indication (e.g., a visual indication, audio indication, tactile indication, a message, etc.) relating to a condition, state, status, etc. of the work machine 1202 to a user and/or observer. For example, the beacon 1212 may be configured to provide an indication relating to a battery charge level of the work machine 1202 (e.g., a green light indicating sufficient charge, a yellow light indicating a mid-level charge, a red light indicating the machine needs to be charged, etc.) in response to a request from a user (e.g., via an application on the user device 272). In some embodiments, the connectivity module 1204 includes additional and/or different working components, for example one or more antennas, one or more power sources, one or more positioning systems (e.g., global positioning services devices, etc.), one or more local fleet connectivity processors, and one or more interface blocks, one or more machine connectivity provisions, and one or more memory devices (e.g., databases, etc.), etc.

In some embodiments, components of the connectivity module 1204 (e.g., the telematics control unit 1206) are also configured to control components of the work machine 1202. For example, the connectivity module 1204 may be configured to selectively enable, activate, disable, and deactivate components of the work machine 1202 (e.g., headlights, a horn, a light, the beacon 1212, the chassis, a control system, a wheel, etc.) in response to a request or command from a user (e.g., via an application on the user device 272). In other embodiments, components of the connectivity module 1204 (e.g., the telematics control unit 1206) are configured to control components of the work machine 1202 in accordance with instructions provided from a user (e.g., via an application on the user device 272). For example, the connectivity module 1204 may provide an indication via the beacon 1212 relating to a status of the work machine 1202 (e.g., a charge status, a fuel level, etc.) in order for a user or observer to more efficiently complete a work flow.

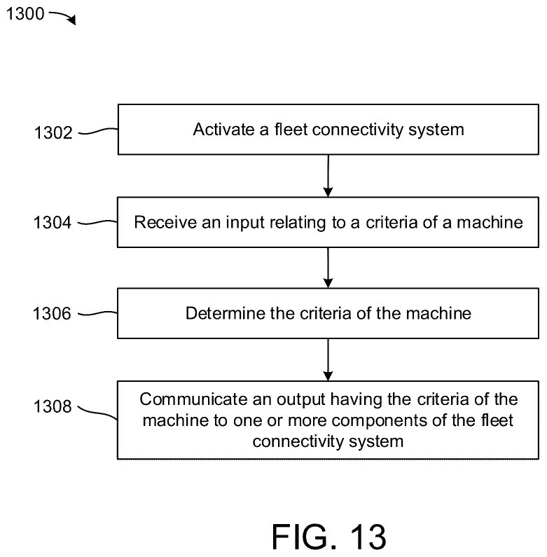

Referring to FIG. 13, a process for implementing components of a fleet connectivity system is shown, according to an exemplary embodiment. The process 1300 may utilize any combination of components described herein (e.g., the fleet connectivity system 200 of FIG. 2, the fleet connectivity system 300 of FIG. 3, the connectivity module 1204 of FIG. 12, etc.). According to an exemplary embodiment, the process 1300 configured to provide an output to one or more components of a work machine in accordance with a criteria of the work machine. In some embodiments, the process 1300 is also configured to control one or more components of a work machine or work machines (e.g., via a connectivity module, a beacon, etc.).

At step 1302, a fleet connectivity system is activated, according to an exemplary embodiment. The fleet connectivity system may be the local fleet connectivity system 200 of FIG. 2, the fleet connectivity system 300 of FIG. 3, the fleet connectivity system 400 of FIG. 4, the fleet connectivity system 600 of FIG. 6, and/or any combination of components thereof. As discussed above, the fleet connectivity system may include one or more work machines, which may include a connectivity module (e.g., the connectivity module 218 of FIG. 2, the connectivity module 320 of FIG. 3, the connectivity module 1204 of FIG. 12, etc.). In an exemplary embodiment, at step 1302 the work machines, devices, equipment systems, etc. of the connectivity system may be deployed to a work site via communications between components of the connectivity system.

At step 1304, an input relating to a work machine criteria is received, according to an exemplary embodiment. In an exemplary embodiment, the input is received from an application on a user device (e.g., the user device 272), for example the input is received at the connectivity module 1204 and/or components of the connectivity module 1204 (e.g., via a network). The input may include a condition, state, and/or status of the machine desired by a user (e.g., fuel level, battery charge level, operational status of a machine, whether a machine needs a diagnostic check, trouble shooting, etc., as discussed above). In other embodiments, the input includes customer and/or commercial services relating to a work machine, provisioning and/or updates to a work machine, pressures and/or positioning of one or more components of the work machine, electronic commerce services, and/or any other suitable information relating to a work machine desired by a user. In some embodiments, the input is received from another suitable system or device, for example a controller of a work machine (e.g., the controller 206, etc.), a sensor of a work machine, a product development hub (e.g., customer subscription management 248 hub, the device provisioning 250 hub, asset allocation 258 hub, etc.), and/or another suitable source. According to an exemplary embodiment, the connectivity module 1204 may further communicate the input to other components of the work machine and/or the connectivity module 1204 (e.g., the analyzer 1208, etc.) in order to determine a criteria of the work machine, as discussed in 1306.

At step 1306, a criteria of the work machine is determined, according to an exemplary embodiment. In an exemplary embodiment, components of the connectivity module 1204 receive the input relating to the criteria of the work machine, and automatically determine the criteria of the work machine. For example, the connectivity module 1204 (e.g., the analyzer 1208, etc.) may determine a status of the work machine (e.g., fuel level, battery charge level, operational status of a machine, whether a machine needs a diagnostic check, trouble shooting, etc.), customer and/or commercial services relating to the work machine, provisioning and/or updates available to the work machine, pressures and/or positioning of one or more components of the work machine (e.g., chassis, platform, boom, lift, etc.), electronic commerce services relating to the work machine, and/or any other suitable information relating to a work machine based on the input.

At step 1308, an output having the criteria of the work machine is communicated to one or more components of the fleet connectivity system, according to an exemplary embodiment. In an exemplary embodiment, the connectivity module 1204 is configured to communicate the output to a component of the work machine (e.g., the beacon 1212, a sensor, an interface, etc.), a user device (e.g., the user device 308), an application, another work machine (e.g., the other work machine 304, etc.), and/or any other suitable component of a fleet connectivity system. For example, the connectivity module 1204 may communicate an output to an indication device (e.g., the beacon 1212, another beacon, a component of the work machine, etc.) in order to provide an indication (e.g., visual, audio, tactile, a message, etc.) relating to the status of the work machine (e.g., a green light indicating sufficient charge, a yellow light indicating a mid-level charge, a red light indicating the machine needs to be charged, etc.). In some embodiments, the connectivity module 1204 is configured to communicate the output (e.g., via the communication modem 1210) to an interface of the work machine in order to provide a message (e.g., via the interface) relating to customer and/or commercial services, electronic commerce services, and/or other services. In other embodiments, the connectivity module 1204 is configured to communicate the output (e.g., via the communication modem 1210) to a control system (e.g., a controller, processor, etc.) of the work machine in order to provide provisioning and/or updates to the systems of the work machine. In yet other embodiments, the connectivity module 1204 (e.g., via the communication modem 1210) is configured to provide the output to components of the work machine (e.g., chassis, platform, boom, a wheel, etc.) in order to provide positioning and/or orientation information relating to the component and/or the work machine. In some embodiments, the connectivity module 1204 is configured to provide the output to another work machine and/or a fleet connectivity hub, in order to provide information relating to one or more work machines in a fleet.

In other embodiments, the connectivity module 1204 (e.g., the telematics control unit 1206) is configured to communicate an output that controls one or more components of the work machine in accordance with the criteria of the work machine. For example, the connectivity module 1204 may communicate an output that controls an indicator device (e.g., the beacon 1212) in order to provide an indication (e.g., visual, audio, tactile, a message, etc.) relating to the status of the work machine (e.g., a green light indicating sufficient charge, a yellow light indicating a mid-level charge, a red light indicating the machine needs to be charged, etc.). In some embodiments, the connectivity module 1204 is configured to provide an output to control an interface of the work machine to provide a message (e.g., via the interface) relating to customer and/or commercial services, electronic commerce services, etc. In other embodiments, the connectivity module 1204 is configured to provide an output to control a control system (e.g., a controller, processor, etc.) of the work machine in order to provide provisioning and/or updates to the systems of the work machine. In yet other embodiments, the connectivity module 1204 is configured to provide an output to control the chassis, platform, boom, a wheel, and/or another component of the work machine in order to reposition and/or reconfigure the work machine. In this regard, in response to a work machine receiving an input relating to a criteria of the work machine (and determining the criteria of the work machine), the connectivity module may provide an output to one or more components of the fleet connectivity system (and/or control the work machine) in order to more efficiently and effectively complete a task. It should be understood that while certain criteria of the work machine are described herein (e.g., status of the work machine, customer and/or commercial services, etc.), any other suitable criteria relating to a work machine are contemplated.

Referring now to FIG. 14, a work machine with a connectivity module with an integrated beacon is shown, according to another exemplary embodiment. According to an exemplary embodiment, the work machine is a fire fighting vehicle, shown as fire fighting vehicle 1402. The fire fighting vehicle 1402 may a fire fighting vehicle (e.g., a turntable ladder truck, a pumper truck, a quint, etc.), an airport fire fighting vehicle, or another suitable fire fighting vehicle (e.g., a tiller fire truck, a pumper truck, another type of response vehicle). In an exemplary embodiment, the fire fighting vehicle 1402 is integrated with, and/or communicates with components of, a fleet connectivity system (e.g., the fleet connectivity system 200, the fleet connectivity system 300, the fleet connectivity system 400, the fleet connectivity system 500, the fleet connectivity network system 700, and/or any combination thereof, etc.).

In an exemplary embodiment, the fire fighting vehicle 1402 includes a connectivity module 1404 that includes and/or is integrated with a multi-function beacon (e.g., shown as beacon 1412). The connectivity module 1404 may be the connectivity module 218 of FIG. 2, the connectivity module 320 of FIG. 3, the connectivity module 1204 of FIG. 12, and/or any other suitable connectivity module. Further, the beacon 1412 may be the indicator 326 of FIG. 3, the beacon 1212 of FIG. 12, and/or another suitable indication system or device configured to provide an indication to a user and/or observer, as discussed above. It should be understood that the connectivity module 1404 and/or the beacon 1412 are configured to perform any of the operations and/or functions of any of the connectivity modules and/or beacons described herein.

As shown in FIG. 14, in an exemplary embodiment the beacon 1412 is a light bar coupled with the fire fighting vehicle 1402. In an exemplary embodiment, the beacon 1412 is an external light bar positioned at a forward portion of a cab of the fire fighting vehicle 1402. In other embodiments, the beacon 1412 is an interior light bar, a visor light, a dashboard light, a LED grill light, a surface mount light, a hideaway LED light, a strobe kit light, a bumper light, a lateral or side surface mount light, or any other suitable light (e.g., tail light, headlight, etc.) and/or indicator (e.g., horn, emergency announcement device, etc.). In an exemplary embodiment, the connectivity module 1404 is integrated (e.g., embedded, combined, housed, etc.) with the beacon 1412.

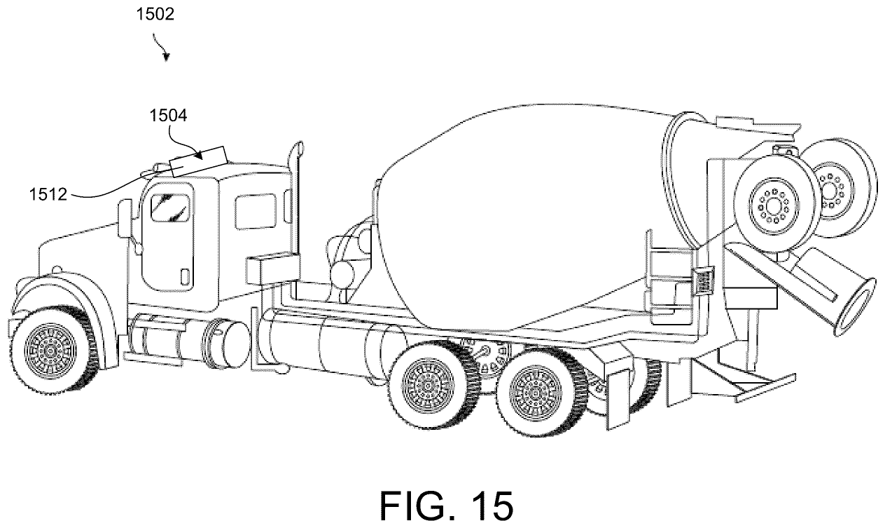

Referring now to FIG. 15, a work machine with a connectivity module with an integrated beacon is shown, according to another exemplary embodiment. According to an exemplary embodiment, the work machine is a concrete mixer vehicle, shown as a mixer truck 1502. The mixer truck 1502 may be a rear-discharge concrete mixer truck; however, in other embodiments, the mixer truck 1502 is another suitable mixer vehicle configuration (e.g., a front-discharge concrete mixer truck). In an exemplary embodiment, the mixer truck 1502 is integrated with, and/or communicates with components of, a fleet connectivity system (e.g., the fleet connectivity system 200, the fleet connectivity system 300, the fleet connectivity system 400, the fleet connectivity system 500, the fleet connectivity network system 700, and/or any combination thereof, etc.).

In an exemplary embodiment, the mixer truck 1502 includes a connectivity module 1504 that includes and/or is integrated with a multi-function beacon (e.g., shown as beacon 1512). The connectivity module 1504 may be the connectivity module 218 of FIG. 2, the connectivity module 320 of FIG. 3, the connectivity module 1204 of FIG. 12, and/or any other suitable connectivity module. Further, the beacon 1512 may be the indicator 326 of FIG. 3, the beacon 1212 of FIG. 12, and/or another suitable indication system or device configured to provide an indication to a user and/or observer, as discussed above. It should be understood that the connectivity module 1504 and/or the beacon 1512 are configured to perform any of the operations and/or functions of any of the connectivity modules and/or beacons described herein.

As shown in FIG. 15, in an exemplary embodiment the beacon 1512 is a light bar coupled with the mixer truck 1502. In an exemplary embodiment, the beacon 1512 is an external light bar positioned at a forward portion of a cab of the mixer truck 1502. In other embodiments, the beacon 1512 is an interior light bar, a visor light, a dashboard light, a LED grill light, a surface mount light, a hideaway LED light, a strobe kit light, a bumper light, a lateral or side surface mount light, or any other suitable light (e.g., tail light, headlight, etc.) and/or indicator (e.g., horn, emergency announcement device, etc.). In an exemplary embodiment, the connectivity module 1504 is integrated (e.g., embedded, combined, housed, etc.) with the beacon 1512.

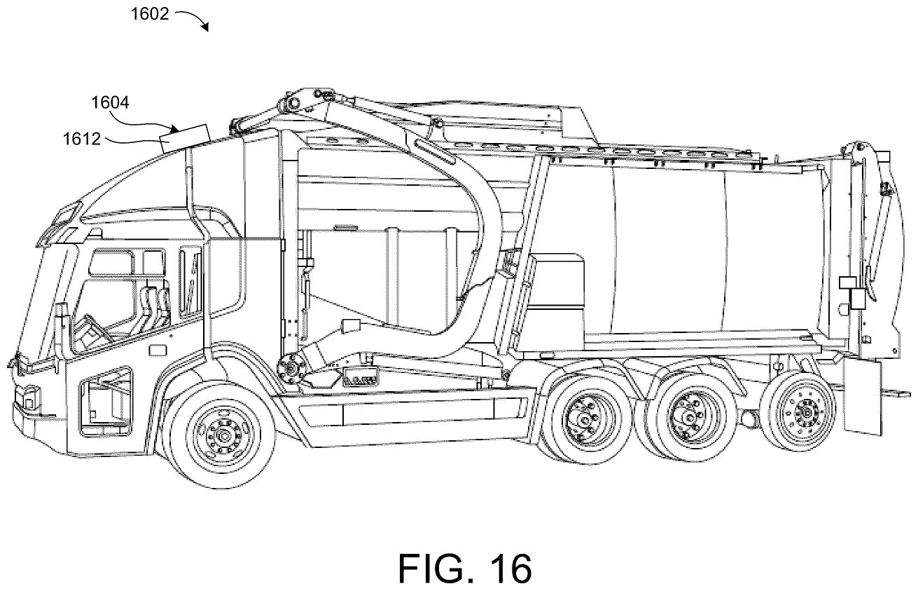

Referring now to FIG. 16, a work machine with a connectivity module with an integrated beacon is shown, according to another exemplary embodiment. According to an exemplary embodiment, the work machine is a refuse vehicle (e.g., a refuse truck, a garbage truck, a waste collection truck, a sanitation truck a recycling truck, etc.), shown as a refuse vehicle 1602. The refuse vehicle 1602 may be a front-loading refuse vehicle (e.g., as shown in at least FIG. 16). In other embodiments, the refuse vehicle 1602 is another suitable refuse vehicle (e.g., a rear-loading refuse vehicle, a side-loading refuse vehicle, etc.). In an exemplary embodiment, the refuse vehicle 1602 is integrated with, and/or communicates with components of, a fleet connectivity system (e.g., the fleet connectivity system 200, the fleet connectivity system 300, the fleet connectivity system 400, the fleet connectivity system 500, the fleet connectivity network system 700, and/or any combination thereof, etc.).

In an exemplary embodiment, the refuse vehicle 1602 includes a connectivity module 1604 that includes and/or is integrated with a multi-function beacon (e.g., shown as beacon 1612). The connectivity module 1604 may be the connectivity module 218 of FIG. 2, the connectivity module 320 of FIG. 3, the connectivity module 1204 of FIG. 12, and/or any other suitable connectivity module. Further, the beacon 1612 may be the indicator 326 of FIG. 3, the beacon 1212 of FIG. 12, and/or another suitable indication system or device configured to provide an indication to a user and/or observer, as discussed above. It should be understood that the connectivity module 1604 and/or the beacon 1612 are configured to perform any of the operations and/or functions of any of the connectivity modules and/or beacons described herein.

As shown in FIG. 16, in an exemplary embodiment the beacon 1612 is a light bar coupled with the refuse vehicle 1602. In an exemplary embodiment, the beacon 1612 is an external light bar positioned at a forward portion of a cab of the refuse vehicle 1602. In other embodiments, the beacon 1612 is an interior light bar, a visor light, a dashboard light, a LED grill light, a surface mount light, a hideaway LED light, a strobe kit light, a bumper light, a lateral or side surface mount light, or any other suitable light (e.g., tail light, headlight, etc.) and/or indicator (e.g., horn, emergency announcement device, etc.). In an exemplary embodiment, the connectivity module 1604 is integrated (e.g., embedded, combined, housed, etc.) with the beacon 1612.

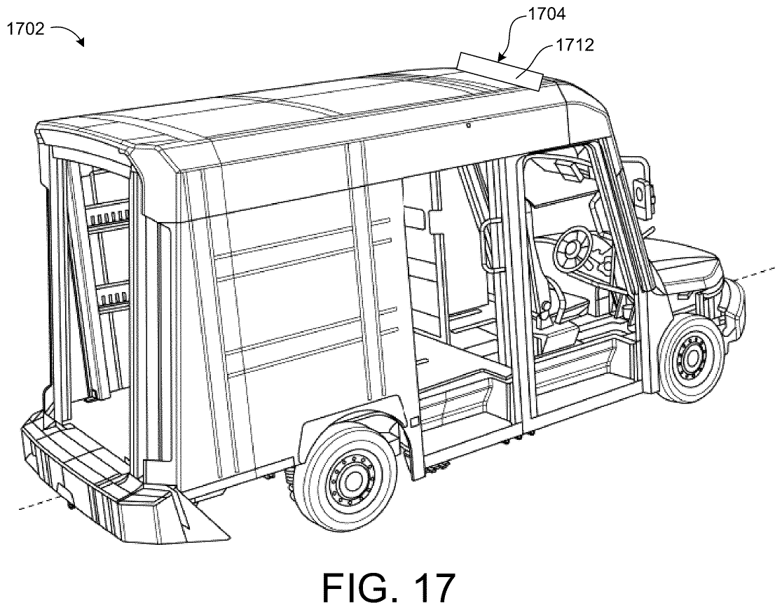

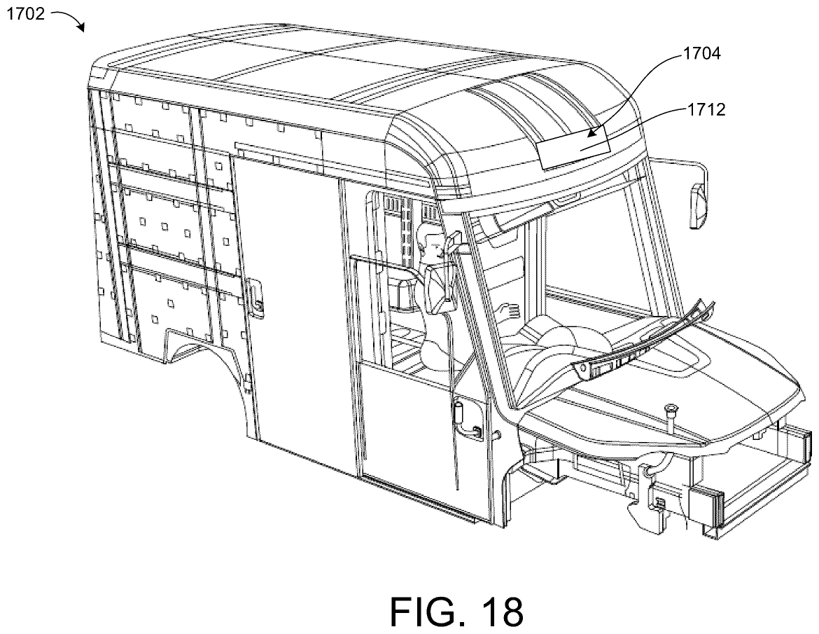

Referring now to FIGS. 17-18, a work machine with a connectivity module with an integrated beacon is shown, according to another exemplary embodiment. According to an exemplary embodiment, the work machine is a delivery vehicle (e.g., a parcel vehicle, a cargo transport vehicle, a mail vehicle, a postal vehicle, a postal van, a truck, a van, etc.), shown as a delivery vehicle 1702. The delivery vehicle 1702 may a specialized vehicle that transports parcels (e.g., mail, packages, etc.) from a distribution center (e.g., a post office, a warehouse, etc.) to various delivery locations (e.g., recipients' homes, offices, etc.). In an exemplary embodiment, the delivery vehicle 1702 is integrated with, and/or communicates with components of, a fleet connectivity system (e.g., the fleet connectivity system 200, the fleet connectivity system 300, the fleet connectivity system 400, the fleet connectivity system 500, the fleet connectivity network system 700, and/or any combination thereof, etc.).

In an exemplary embodiment, the delivery vehicle 1702 includes a connectivity module 1704 that includes and/or is integrated with a multi-function beacon (e.g., shown as beacon 1712). The connectivity module 1704 may be the connectivity module 218 of FIG. 2, the connectivity module 320 of FIG. 3, the connectivity module 1204 of FIG. 12, and/or any other suitable connectivity module. Further, the beacon 1712 may be the indicator 326 of FIG. 3, the beacon 1212 of FIG. 12, and/or another suitable indication system or device configured to provide an indication to a user and/or observer, as discussed above. It should be understood that the connectivity module 1704 and/or the beacon 1712 are configured to perform any of the operations and/or functions of any of the connectivity modules and/or beacons described herein.

As shown in FIGS. 17-18, in an exemplary embodiment the beacon 1712 is a light bar coupled with the delivery vehicle 1702. In an exemplary embodiment, the beacon 1712 is an external light bar positioned at a forward portion of a cab of the delivery vehicle 1702 (as shown in FIG. 17). In other embodiments, the beacon 1712 is an interior light bar positioned at a forward portion of a cab of the delivery vehicle 1702 (as shown in FIG. 18). In other embodiments, the beacon 1712 is a visor light, a dashboard light, a LED grill light, a surface mount light, a hideaway LED light, a strobe kit light, a bumper light, a lateral or side surface mount light, or any other suitable light (e.g., tail light, headlight, etc.) and/or indicator (e.g., horn, emergency announcement device, etc.). In an exemplary embodiment, the connectivity module 1704 is integrated (e.g., embedded, combined, housed, etc.) with the beacon 1712.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

While various circuits with particular functionality are shown in FIGS. 1-3, it should be understood that the controller 44 may include any number of circuits for completing the functions described herein. For example, the activities and functionalities of the control system 60 may be combined in multiple circuits or as a single circuit. Additional circuits with additional functionality may also be included. Further, the controller 44 may further control other activity beyond the scope of the present disclosure.

As mentioned above and in one configuration, the “circuits” of the control system 60 may be implemented in machine-readable medium for execution by various types of processors, such as the processor 52 of FIG. 1. An identified circuit of executable code may, for instance, comprise one or more physical or logical blocks of computer instructions, which may, for instance, be organized as an object, procedure, or function. Nevertheless, the executables of an identified circuit need not be physically located together, but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits, and may be embodied in any suitable form and organized within any suitable type of data structure. The operational data may be collected as a single data set, or may be distributed over different locations including over different storage devices, and may exist, at least partially, merely as electronic signals on a system or network.

While the term “processor” is briefly defined above, the term “processor” and “processing circuit” are meant to be broadly interpreted. In this regard and as mentioned above, the “processor” may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

Although this description may discuss a specific order of method steps, the order of the steps may differ from what is outlined. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps, and decision steps.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

It is important to note that the construction and arrangement of the load map interface systems and methods as shown in the various exemplary embodiments is illustrative only. Additionally, any element disclosed in one embodiment may be incorporated or utilized with any other embodiment disclosed herein. For example, the warning zones of the exemplary embodiment may be eliminated or additional zones may be added. Although only one example of an element from one embodiment that can be incorporated or utilized in another embodiment has been described above, it should be appreciated that other elements of the various embodiments may be incorporated or utilized with any of the other embodiments disclosed herein.

Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A machine, comprising:
a chassis;
a plurality of tractive elements coupled with the chassis;
a prime mover configured to drive the plurality of tractive elements; and
a connectivity module with a beacon communicably coupled with the machine, wherein the connectivity module is configured to:
receive an input relating to a criteria of the machine; and
communicate an output, the output including the criteria of the machine, to one or more components of the machine.

2. The machine of claim 1, wherein the criteria of the machine is at least one of a fuel level of the machine, a battery power level of the machine, an ignition status of the machine, and an operational status of the machine.

3. The machine of claim 1, wherein the connectivity module is configured to communicate the output to the beacon in order to provide an indication of a status of the machine to an observer.

4. The machine of claim 3, wherein the indication is at least one of the beacon being in a solid on state, a solid off state, a flashing state, and a strobe state.

5. The machine of claim 1, wherein the connectivity module is configured to communicate the output to an interface of the machine in order to provide a message to a user relating to commercial services.

6. The machine of claim 1, wherein the connectivity module is configured to communicate the output to a control system of the machine in order to provide a software update to the machine.

7. The machine of claim 1, wherein the connectivity module is configured to communicate the output to the prime mover of the machine in order to reposition the machine.

8. The machine of claim 1, wherein the connectivity module is configured to communicate the output to an interface of the machine in order to provide a message to a user relating to commerce services relating to the machine.

9. The machine of claim 1, wherein the machine is a lift device.

10. The machine of claim 1, wherein the machine includes at least one of an articulating arm and a movable structure coupled with the chassis.

11. A vehicle, comprising:
a chassis;
a plurality of tractive elements coupled with the chassis;
a prime mover configured to drive the plurality of tractive elements; and
a connectivity module with a beacon communicably coupled with the vehicle, wherein the connectivity module is configured to:
receive an input relating to a criteria of the vehicle; and
communicate an output, the output including the criteria of the vehicle, to one or more components of the vehicle.

12. The vehicle of claim 11, wherein the criteria of the vehicle is at least one of a fuel level of the vehicle, a battery power level of the vehicle, an ignition status of the vehicle, and an operational status of the vehicle.

13. The vehicle of claim 11, wherein the connectivity module is configured to communicate the output to the beacon in order to provide an indication of a status of the vehicle to an observer.

14. The vehicle of claim 13, wherein the indication is at least one of the beacon being in a solid on state, a solid off state, a flashing state, and a strobe state.

15. The vehicle of claim 11, wherein the connectivity module is configured to communicate the output to an interface of the vehicle in order to provide a message to a user relating to commercial services.

16. The vehicle of claim 11, wherein the connectivity module is configured to communicate the output to a control system of the vehicle in order to provide a software update to the vehicle.

17. The vehicle of claim 11, wherein the vehicle is a lift device.

18. A fleet connectivity system, comprising:
a user device; and
a machine, comprising:
a chassis;
a plurality of tractive elements coupled with the chassis;
a prime mover configured to drive the plurality of tractive elements; and
a connectivity module with a beacon communicably coupled with the machine, wherein the connectivity module is configured to:
receive an input relating to a criteria of the machine; and
communicate an output, the output including the criteria of the machine, to one or more components of the machine;
wherein the user device is configured to receive the input from a user and communicate the input to the connectivity module.

19. The fleet connectivity system of claim 18, wherein the criteria of the machine is at least one of a fuel level of the machine, a battery power level of the machine, an ignition status of the machine, and an operational status of the machine.

20. The fleet connectivity system of claim 18, wherein the connectivity module is configured to communicate the output to the beacon in order to provide an indication of a status of the machine to an observer.
